(19) United States
(12) Patent Application Publication
(10) Pub. No.: US 2025/0336230 A1
(43) Pub. Date: Oct. 30, 2025

(54) PALM PRINT RECOGNITION METHOD, RELATED APPARATUS, AND MEDIUM

(71) Applicant: Tencent Technology (Shenzhen) Company Limited, Shenzhen (CN)

(72) Inventors: Lei SHEN, Shenzhen (CN); Ruixin Zhang, Shenzhen (CN); Shouhong Ding, Shenzhen (CN)

(73) Assignee: Tencent Technology (Shenzhen) Company Limited, Shengzhen (CN)

(21) Appl. No.: 19/264,241

(22) Filed: Jul. 9, 2025

Related U.S. Application Data
(63) Continuation of application No. PCT/CN2024/087678, filed on Apr. 15, 2024.

(30) Foreign Application Priority Data
May 16, 2023 (CN) 202310726912.6

(51) Int. Cl. G06V 40/12

(52) U.S. Cl. CPC G06V 40/1365

(57) ABSTRACT

A palm print recognition method includes acquiring a target palm image, determining a target region in the target palm image in which palm print information richness satisfies a preset condition, determining a plurality of target sub-regions in the target region, the plurality of target sub-regions not overlapping with each other, determining a second feature of the target region based on first features of the plurality of target sub-regions, and determining a palm print recognition result corresponding to the target palm image based on the second feature of the target region.

### CROSS-REFERENCE TO RELATED APPLICATIONS

This application is a continuation application of International Application No. PCT/CN2024/087678 filed on Apr. 15, 2024, which claims priority to Chinese Patent Application No. 202310726912.6 filed with the China National Intellectual Property Administration on Jun. 16, 2023, the disclosures of each being incorporated by reference herein in their entireties.

### FIELD

The disclosure relates to the field of biological feature recognition, and in particular, to a palm print recognition technology.

### BACKGROUND

In the existing palm print recognition technology, common palm print recognition methods include the following three types. In the first method, texture line feature points are extracted from an entire palm print image, and palm print recognition is performed based on a Euclidean distance between the texture line feature points. In the second method, an entire palm print image is converted into a low-dimensional vector and then classified to perform palm print recognition. In the third method, an entire palm print image is inputted into a deep learning model to perform palm print recognition.

However, in the above methods, when facing a large number of highly similar palm print images, sufficiently discriminative features cannot be extracted to distinguish different palm print images, which results in reduced recognition accuracy.

### SUMMARY

Some embodiments provide a palm print recognition method including: acquiring a target palm image; determining a target region in the target palm image, the target region being a region in which palm print information richness in the target palm image satisfies a preset condition; determining a plurality of target sub-regions in the target region, the plurality of target sub-regions not overlapping with each other; determining a second feature of the target region based on first features of the plurality of target sub-regions; and determining a palm print recognition result corresponding to the target palm image based on the second feature of the target region.

Some embodiments provide a palm print recognition apparatus including: at least one memory configured to store computer program code; and at least one processor configured to read the program code and operate as instructed by the program code, the program code comprising: first acquisition code configured to cause at least one of the at least one processor to acquire a target palm image; second acquisition code configured to cause at least one of the at least one processor to determine a target region in the target palm image, the target region being a region in which palm print information richness in the target palm image satisfies a preset condition; third acquisition code configured to cause at least one of the at least one processor to determine a plurality of target sub-regions in the target region, the plurality of target sub-regions not overlapping with each other; fourth acquisition code configured to cause at least one of the at least one processor to determine a second feature of the target region based on first features of the plurality of target sub-regions; and fifth acquisition code configured to cause at least one of the at least one processor to determine a palm print recognition result corresponding to the target palm image based on the second feature of the target region.

Some embodiments provide a non-transitory computer-readable storage medium, storing computer code which, when executed by at least one processor, causes the at least one processor to at least: acquire a target palm image; determine a target region in the target palm image, the target region being a region in which palm print information richness in the target palm image satisfies a preset condition; determine a plurality of target sub-regions in the target region, the plurality of target sub-regions not overlapping with each other; determine a second feature of the target region based on first features of the plurality of target sub-regions; and determine a palm print recognition result corresponding to the target palm image based on the second feature of the target region.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is an architecture diagram of a system applied by a palm print recognition method according to some embodiments.

FIG. 2A to FIG. 2C are schematic diagrams of a palm print recognition method in a mobile payment scene according to some embodiments.

FIG. 2D to FIG. 2F are schematic diagrams of a palm print recognition method in an identity verification scene according to some embodiments.

FIG. 3 is a flowchart of a palm print recognition method according to some embodiments.

FIG. 4A to FIG. 4C are interface schematic diagrams of operation in FIG. 3 according to some embodiments.

FIG. 5A to FIG. 5C are interface schematic diagrams of operation in FIG. 3 according to some embodiments.

FIG. 6 is a flowchart of operation in FIG. 3 according to some embodiments.

FIG. 7A is a schematic diagram of a rectangular coordinate system established according to some embodiments.

FIG. 7B is a schematic diagram of determining a target region center based on a rectangular coordinate system according to some embodiments.

FIG. 8A is a schematic diagram of a circumcircle established according to some embodiments.

FIG. 8B is a schematic diagram of determining a target region center based on a circumcircle according to some embodiments.

FIG. 9 is a flowchart of operation in FIG. 6 according to some embodiments.

FIG. 10A to FIG. 10B are schematic diagrams of processes of operation to operation in FIG. 9 according to some embodiments.

FIG. 11 is a flowchart of operation in FIG. 6 according to some embodiments.

FIG. 12A to FIG. 12C are schematic diagrams of a generation process of a target region in a case that the target region is a square according to some embodiments.

FIG. 13 is a flowchart of operation in FIG. 6 according to some embodiments.

FIG. 14A to FIG. 14C are schematic diagrams of a generation process of a target region in a case that the target region is a square according to some embodiments.

FIG. 14D to FIG. 14E are schematic diagrams of a generation process of a target region in a case that the target region is a circle according to some embodiments.

FIG. 15 is a flowchart of operation in FIG. 3 according to some embodiments.

FIG. 16 is a schematic diagram of a process of acquiring a plurality of target sub-regions using partitions according to some embodiments.

FIG. 17 is a flowchart of operation in FIG. 3 according to some embodiments.

FIG. 18A to FIG. 18B are schematic diagrams of a process of acquiring a plurality of target sub-regions using an acquired target sub-region set according to some embodiments.

FIG. 19 is a flowchart of acquiring a first length and a second length in FIG. 17 according to some embodiments.

FIG. 20 is a flowchart of operation in FIG. 3 according to some embodiments.

FIG. 21 is a schematic diagram of a process of transforming into the same size in FIG. 20 according to some embodiments.

FIG. 22 is a flowchart of operation in FIG. 20 according to some embodiments.

FIG. 23 is a schematic diagram of a process of acquiring a second feature with reference to projection convolution and position encoding in FIG. 22 according to some embodiments.

FIG. 24 is a schematic structural diagram of a projection convolution model according to some embodiments.

FIG. 25 is a flowchart of acquiring a second feature with reference to a feature encoding model in FIG. 22 according to some embodiments.

FIG. 26A to FIG. 26E are schematic diagrams of a process of acquiring a second feature with reference to three matrices in FIG. 25 according to some embodiments.

FIG. 27 is a schematic structural diagram of a feature encoding model according to some embodiments.

FIG. 28 is a flowchart of operation in FIG. 3 according to some embodiments.

FIG. 29 is a flowchart of acquiring a reference feature vector library in FIG. 28 according to some embodiments.

FIG. 30 is a flowchart of a specific implementation of jointly training a projection convolution model and a convolutional encoding model in FIG. 29 according to some embodiments.

FIG. 31 is an overall flowchart of a palm print recognition method according to some embodiments.

FIG. 32 is a module diagram of a palm print recognition apparatus according to some embodiments.

FIG. 33 is a structural diagram of a terminal of a palm print recognition method according to some embodiments.

FIG. 34 is a structural diagram of a server of a palm print recognition method according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Before embodiments are described in further detail, nouns and terms involved in various embodiments are described. The nouns and terms involved in the embodiments are applicable to the following explanations.

Palm print recognition technology: palm print recognition is a relatively new biological feature recognition technology. The identity is recognized by recognizing a palm image from fingertips to a wrist. It has features such as simple sampling, rich image information, high user acceptance, difficulty in forgery, and little noise interference. Currently, the palm print recognition technology has been applied to the fields such as mobile payment and identity verification. Compared with the face recognition technology, the palm print, due to the concealment, is more conducive to protecting user privacy, while not being affected by factors such as masks, makeup, and sunglasses, which may reduce the recognition accuracy.

Since most regions of the palm are non-discriminative for palm print recognition, in some embodiments, performing palm print recognition based on the entire palm image is innovatively discarded. Instead, the target region including rich palm print information is acquired from the target palm image, and features in the target region have relatively high discriminability. Then, in some embodiments, a plurality of target sub-regions are determined in the target region, features are extracted from the target sub-region, and the feature of the target region is determined based on the features of the plurality of target sub-regions. Thus, the determined feature covers a plurality of highly discriminative positions in the palm, thereby helping improve the accuracy of palm print recognition.

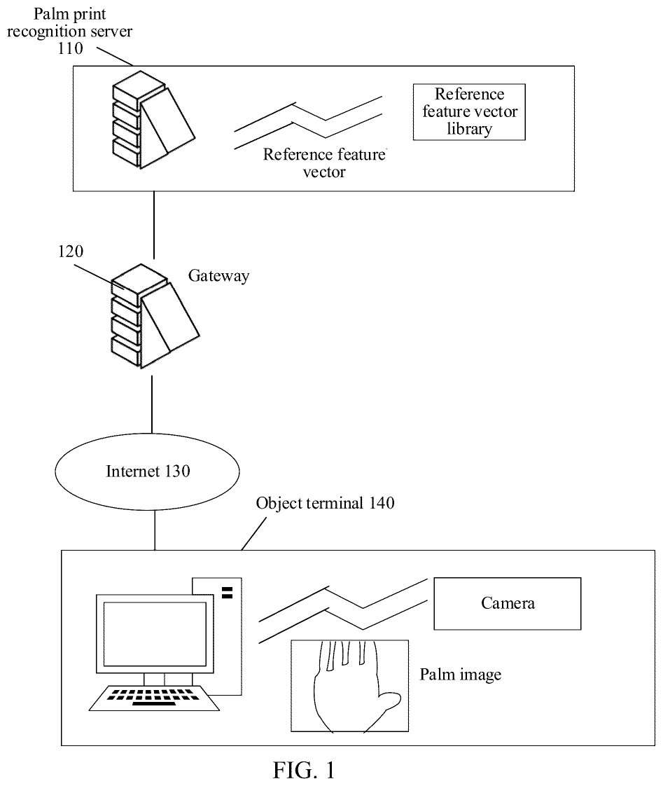

FIG. 1 is an architecture diagram of a system applied by a palm print recognition method according to some embodiments. The system includes an object terminal 140, an Internet 130, a gateway 120, a palm print recognition server 110, and the like.

The object terminal 140 may include, but is not limited to, a desktop computer, a laptop computer, a personal digital assistant (PDA), a mobile phone, an in-vehicle terminal, a dedicated terminal, and the like. In some embodiments, the object terminal 140 may be specifically embodied in the form of a mobile phone, a tablet, a punch clock, an identity verification dedicated terminal, a payment dedicated terminal, or the like. In addition, the object terminal 140 may be a single device or a collection of a plurality of devices. The object terminal 140 may communicate with and exchange data with the palm print recognition server 110 through the Internet 130. The Internet 130 may be a wired network or a wireless network.

A camera of the object terminal 140 is a module configured to acquire a palm image. The camera may be provided in the object terminal 140. In some embodiments, the camera communicates with the object terminal 140 in a wireless or wired manner so that the object terminal 140 can receive the palm image acquired by the camera.

The palm print recognition server 110 is a computer system configured to provide a palm print recognition service for the object terminal 140. Compared with the object terminal 140, the palm print recognition server 110 has higher requirements in terms of stability, security, performance, and the like. The palm print recognition server 110 may be a high-performance computer in a network platform, a cluster formed by a plurality of high-performance computers, a part (for example, a virtual machine) of a high-performance computer, a combination of parts (for example, virtual machines) of a plurality of high-performance computers, or the like. In some application scenes (such as a mobile payment scene mentioned below), the palm print recognition server 110 can perform corresponding palm print recognition after obtaining a palm image. For example, after receiving the palm image, the palm print recognition server 110 performs feature extraction on the palm image to obtain a target palm print vector, compares the target palm print vector with a reference feature vector in a reference feature vector library to obtain a palm print recognition result, and determines a user corresponding to the palm image.

The gateway 120 may be referred to as an inter-network connector or a protocol converter. The gateway 120 implements network interconnection on a transport layer and is a computer system or device providing a conversion function. The gateway 120 is a translator between two systems that use different communication protocols, data formats or languages, or even completely different architectures. Meanwhile, the gateway 120 may further provide filtering and security functions. A message transmitted by the object terminal 140 to the palm print recognition server 110 needs to be transmitted to the corresponding palm print recognition server 110 through the gateway 120. A message transmitted by the palm print recognition server 110 to the object terminal 140 also needs to be transmitted to the corresponding object terminal 140 through the gateway 120.

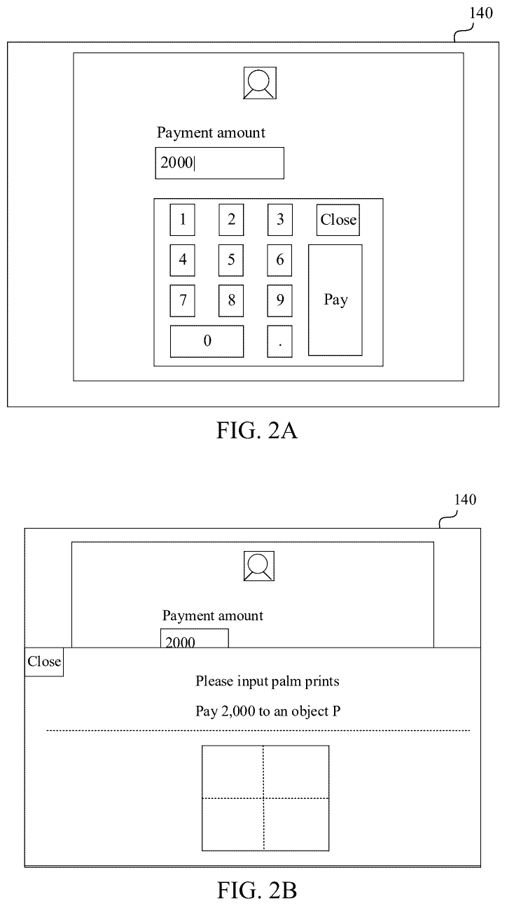

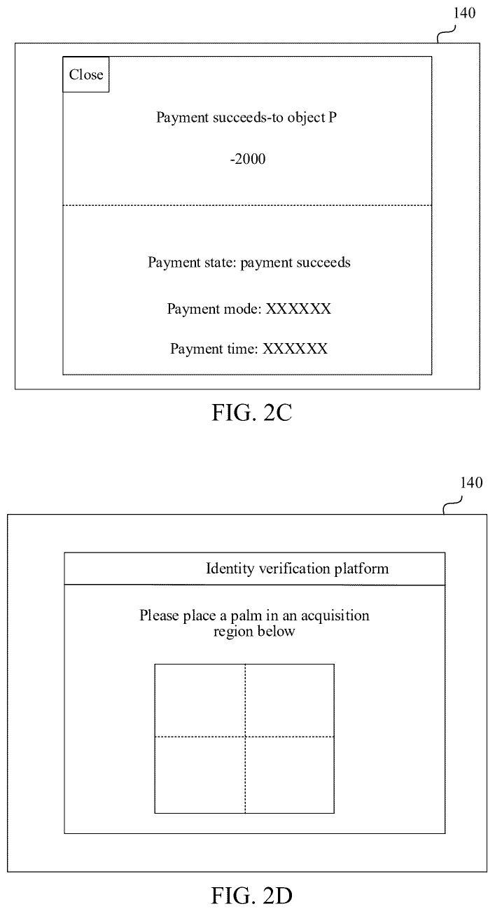

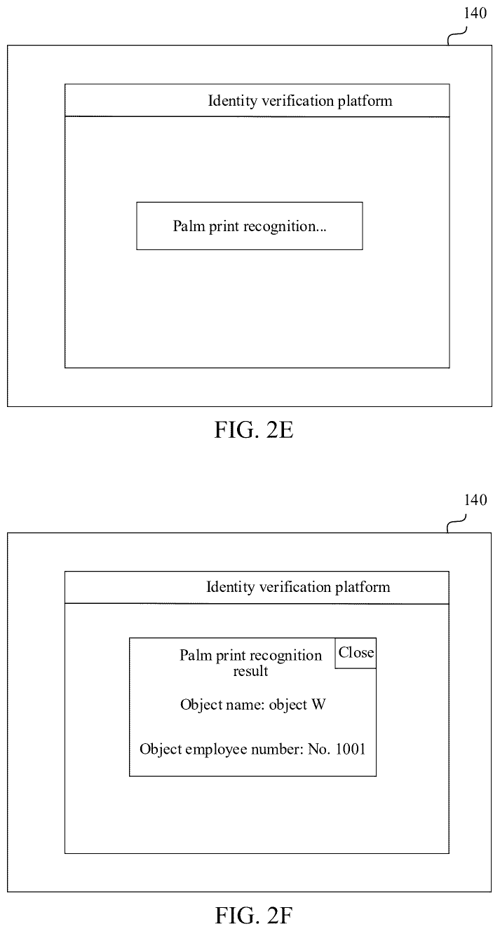

Some embodiments may be applied to various scenes, for example, mobile payment scenes shown in FIG. 2A to FIG. 2C and identity verification scenes shown in FIG. 2D to FIG. 2F.

### (1) Mobile Payment Scene

The mobile payment scene refers to a scene in which payment is performed through the object terminal 140 according to a palm print of an object.

As shown in FIG. 2A, the object terminal 140 is a payment terminal, for example, a mobile phone. When an object W performs payment through the object terminal 140, a display screen of the object terminal 140 displays a payment page. An avatar of an object P (the object P refers to an object receiving payment) and an input box are displayed on the payment page. The object W inputs “2,000” in the input box, and a payment amount on the payment page is “2,000”. There is a payment control at a lower right corner of the input box. The payment control is configured to support the object W to click and start palm print payment check.

As shown in FIG. 2B, after the object W clicks the payment control, the object terminal 140 displays a palm print recognition page. A first prompt and a palm acquisition box are displayed on the palm print recognition page. Content of the first prompt may be “Please input palm prints, and pay 2,000 to the object P”. The palm acquisition box is configured to display the image acquired by the camera of the object terminal 140. The object W may adjust a position of the palm so that the image displayed in the palm acquisition box includes the palm of the object W, and the object terminal 140 obtains the palm image of the object W. From acquiring the palm image by the object terminal 140, a palm print recognition procedure is entered, and palm print recognition is performed according to the palm image. For example, the palm print recognition is performed according to a part of the palm image of the object W, but the recognition fails. For another example, the palm print recognition is performed according to the complete palm image of the object W, and the recognition succeeds, thereby completing payment.

As shown in FIG. 2C, after the payment succeeds, the object terminal 140 may display a payment result page. There is a second prompt on the payment result page. Content of the second prompt may be “payment succeeds-to object P”, “−2,000”, “payment state: payment succeeds”, “payment mode: XXXXXX”, and “payment time: XXXXXX”. The object W may click a close control in the payment result page to close the payment result page.

### (2) Identity Verification Scene

The identity verification scene is a scene in which identity verification is performed through the object terminal 140 according to a palm print of an object.

As shown in FIG. 2D, the object terminal 140 is an identity verification terminal, for example, a punch clock. When the object W performs identity verification through the object terminal 140, the object terminal 140 enters an identity verification procedure and displays an identity verification page. A third prompt and a palm acquisition box are displayed on the identity verification page. Content of the third prompt includes “Please place a palm in an acquisition region below”. The palm acquisition box is configured to display the image acquired by the camera of the object terminal 140. The object W may adjust a position of the palm so that the image displayed in the palm acquisition box includes the palm of the object W, and the object terminal 140 obtains the palm image of the object W.

As shown in FIG. 2E, the object terminal 140 performs palm print recognition based on the palm image and displays a first pop-up window on a page. Content of the first pop-up window includes “palm print recognition . . . ”, to prompt the object W of a recognition progress.

As shown in FIG. 2F, after recognition succeeds, the object terminal 140 displays a second pop-up window on the page. Content of the second pop-up window includes “palm print recognition result”, “object name: object W”, and “object employee number: No. 1001”. The object W may click a close control in the identity verification page to close the identity verification page.

In the foregoing mobile payment scene and identity verification scene, palm print recognition needs to be performed based on the palm image. A palm print recognition process may include first extracting a first palm print feature based on the palm image, then calculating feature distances among the first palm print feature and second palm print features in a palm print database, and then determining an object corresponding to a second palm print feature with a smallest distance to the first palm print feature as a target recognized object to obtain a palm print recognition result.

Compared with the identity verification scene or another product (for example, a punch clock) that performs palm print recognition based on a palm image, the mobile payment scene is a scene that has a relatively high requirement on recognition accuracy and has the following difficulties.

(1) The recognition difficulty is high for a highly similar sample pair: in the field of palm print recognition, a highly similar sample pair is mainly concentrated on palms of identical twins. Most palm print lines of this type of palms are very similar, and only a small part of main lines and some fine lines are different. Therefore, in the mobile payment scene, the following situations are likely to occur: palm print recognition is performed based on a palm image of a first object in the twins, but the palm print was mistakenly identified as a second subject in twins, leading to a situation where the payment is successful but the payment object is incorrect.

(2) The extraction difficulty is high for a discriminative palm print feature in the palm image: the number of objects in the mobile payment scene is very large, that is, a palm print database stores palm print features corresponding to a large number of objects. Under a large number of objects, palm prints of many objects are different only at details. However, in the related art, feature extraction is usually performed based on an entire palm image, and sufficiently discriminative feature points often cannot be extracted so that different palm print images cannot be effectively distinguished.

For the foregoing problem, some embodiments provide a palm print recognition method that can resolve the foregoing problem. The palm print recognition method provided by some embodiments is described in detail below.

According to some embodiments, a palm print recognition method is provided.

The palm print recognition method refers to a method in which palm print features are extracted based on a palm image to determine a palm print recognition result according to the palm print features. The palm print recognition method in some embodiments may be applied to a scene with a relatively high requirement on recognition accuracy, for example, the mobile payment scenes shown in FIG. 2A to FIG. 2C.

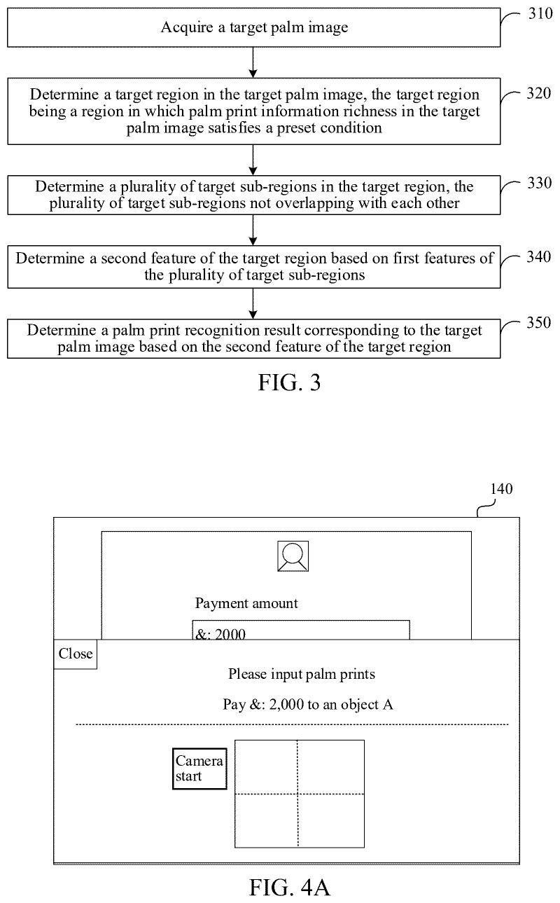

As shown in FIG. 3, the palm print recognition method according to some embodiments may include the following operations.

Operation 310: Acquire a target palm image.

Operation 320: Determine a target region in the target palm image, the target region being a region in which palm print information richness in the target palm image satisfies a preset condition.

Operation 330: Determine a plurality of target sub-regions in the target region, the plurality of target sub-regions not overlapping with each other.

Operation 340: Determine a second feature of the target region based on first features of the plurality of target sub-regions.

Operation 350: Determine a palm print recognition result corresponding to the target palm image based on the second feature of the target region.

Operation 310 to operation 350 are described in detail below.

The palm print recognition method may be performed by an electronic device, and specifically, may be performed by the object terminal 140 shown in FIG. 1 or the server 110 shown in FIG. 1.

In operation 310, the target palm image is acquired. The target palm image refers to a palm image that triggers the start of the palm print recognition service.

In some embodiments, manners of acquiring the target palm image include but are not limited to the following manners.

(1) The target palm image is acquired from an image database.

(2) A camera is started to perform image acquisition to acquire the target palm image.

In manner (2), considering that the object W does not necessarily agree to turn on the camera, in some embodiments, the object needs to select whether to start the camera.

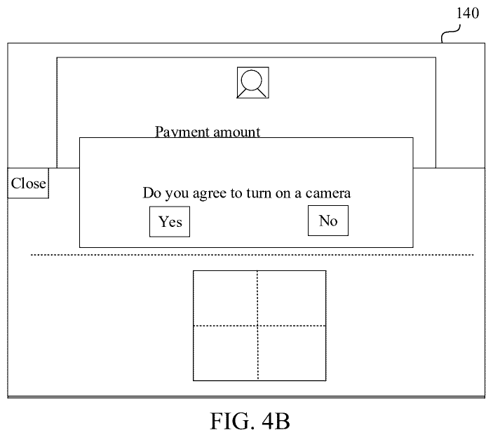

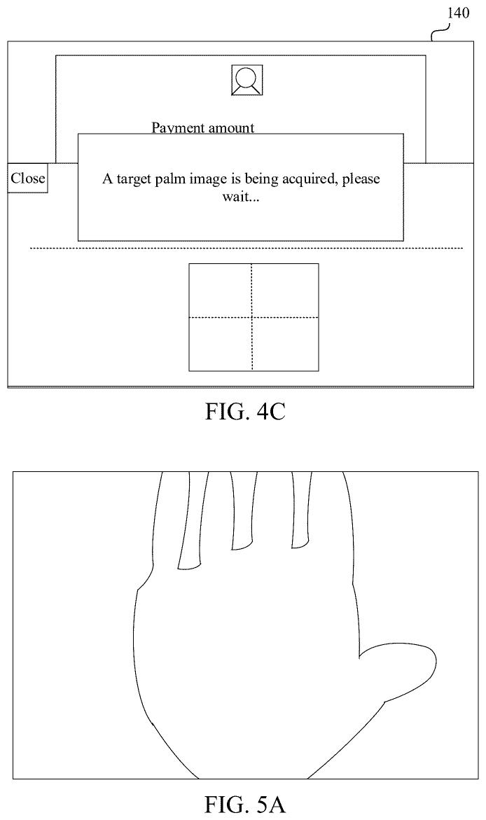

Several manners of starting the camera are described below with reference to FIG. 4A to FIG. 4B.

(1) Referring to FIG. 4A, a “camera start” button is displayed on an interface of the object terminal 140, and after the object W clicks the “camera start” button, the object terminal 140 starts the camera to acquire an image.

(2) Referring to FIG. 4B, an inquiry pop-up window is displayed on an interface of the object terminal 140, and content of the inquiry pop-up window includes “Do you agree to turn on a camera” and two controls, i.e., “Yes” and “No”. After the object W clicks the “Yes” control, the object terminal 140 starts the camera to acquire an image.

After the camera is started, referring to FIG. 4C, a prompt pop-up window is displayed on an interface of the object terminal 140, and content of the prompt pop-up window includes “A target palm image is being acquired, please wait . . . ”, to prompt the object W of a palm image acquisition progress.

In operation 320, the target region is determined in the target palm image. Specifically, the target region may be determined in a manner of determining a target base point in the target palm image. That is, the target base point is first determined in the target palm image, and then the target region is determined in the target palm image based on the target base point.

In some embodiments, the target region may be determined in the target palm image in another manner. For example, the target region in the target palm image may be determined through an image processing model configured to determine a palm print region. This is not limited thereto.

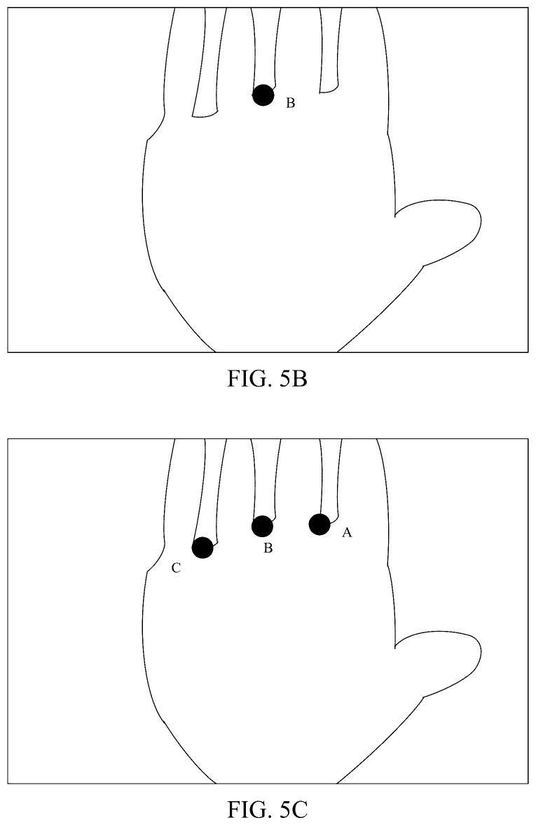

The target base point refers to one or more points that can be used as base points on the target palm image. Specifically, the target base point is a base reference point that is in the target palm image and configured to determine a region having rich palm print information (i.e., the target region), and may be, for example, a finger gap point. The target palm image is shown in FIG. 5A.

In some embodiments, manners of determining the target base point may include but are not limited to the following manners.

(1) A detection model detects an intersection point of a finger gap and the palm in the target palm image and uses the detected intersection point as the target base point. For example, the detection model is a yolov2 model, and an intersection point of a middle finger gap and the palm (an intersection point of a finger gap between middle and ring fingers and the palm) may be detected through a yolov2-based finger gap point detector to obtain the target base point. As shown in FIG. 5B, the intersection point of the finger gap between middle and ring fingers and the palm is a point B, and the target base point includes the point B.

(2) The detection model detects intersection points of three finger gaps and the palm in the target palm image and uses the intersection points of three finger gaps and the palm as the target base point. For example, the detection model is a yolov2 model, and the intersection points of the three finger gaps, i.e., a finger gap between index and middle fingers, a finger gap between middle and ring fingers, and a finger gap between ring and little fingers, and the palm may be detected through a yolov2-based finger gap point detector to obtain the target base point. As shown in FIG. 5C, the intersection points of the three finger gaps and the palm include a point A, a point B, and a point C. Therefore, the target base point includes the point A, the point B, and the point C.

The target region is determined in the target palm image based on the target base point. The target region refers to a region that is located on the target palm image and determined based on the target base point. The target region includes rich palm print information, that is, the palm print information richness in the target region satisfies a preset condition. The target region is a part of the target palm image, that is, recognition is not performed based on the entire palm image in some embodiments. In this way, some processing resources may be saved, and the recognition efficiency may be improved. The target region is a region including rich palm print information, that is, the target region may represent a discriminative region in the palm image, and another non-discriminative region or less-discriminative region is not included in the target region. Therefore, performing palm print recognition based on the target region can still ensure the recognition accuracy. A manner of acquiring the target region is introduced in the detailed description of operation 320 below.

Determining, based on the target base point, the target region on which palm print recognition is performed in the target palm image may ensure that the determined target region includes rich palm print information, that is, ensure that the target region is a discriminative region, which helps improve the accuracy of palm print recognition.

In operation 330, the plurality of target sub-regions are determined in the target region, and the plurality of target sub-regions do not overlap with each other. To further improve the recognition precision, according to some embodiments, the target region is divided into a plurality of target sub-regions, and the target sub-region is a part of the target region. Sizes of the plurality of target sub-regions may be the same or may be different. A manner of acquiring the plurality of target sub-regions is introduced in the detailed description of operation 330 below.

In operation 340, the second feature of the target region is determined based on the first features of the plurality of target sub-regions. The first feature refers to a feature of the target sub-region. One first feature represents one target sub-region and indicates information included in the target sub-region represented by the first feature. A plurality of target sub-regions correspondingly correspond to a plurality of first features. The second feature refers to a feature of the target region. One second feature represents the entire target region and indicates information included in the entire target region. Compared with the second feature directly determined according to the target region, the second feature obtained based on fusion of the plurality of first features can further improve the palm print recognition precision. A manner of acquiring the second feature of the target region is introduced in the detailed description of operation 340 below.

In operation 350, the palm print recognition result of the target palm image is acquired based on the second feature of the target region. The palm print recognition result refers to an output result obtained after palm print recognition is performed on the target palm image. For example, the palm print recognition result is an object corresponding to the target palm image. As shown in FIG. 2F, the palm print recognition result includes the object name and the object employee number. A manner of acquiring the palm print recognition result is introduced in the detailed description of operation 350 below.

According to the foregoing operation 310 to operation 350, according to some embodiments, sampling and learning are performed on the first features corresponding to the plurality of target sub-regions included in the target region in the palm image so that the second feature corresponding to the target region extracted from the target palm image covers a plurality of highly discriminative positions in the palm, thereby improving the accuracy of palm print recognition.

In operation 320, the target region may be acquired from the target palm image based on the target base point.

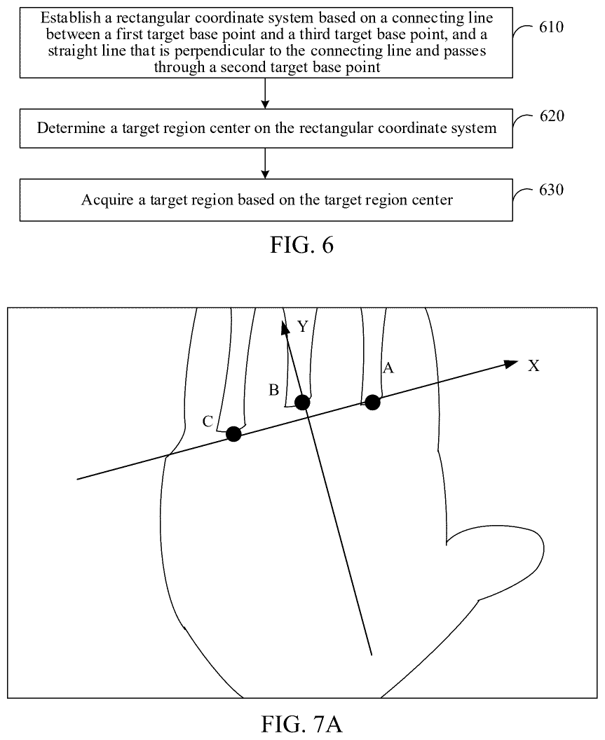

In some embodiments, the target base point includes a first target base point, a second target base point, and a third target base point, and the second target base point is located between the first target base point and the third target base point. Referring to FIG. 6, operation 330 includes the following operations.

Operation 610: Establish a rectangular coordinate system based on a connecting line between the first target base point and the third target base point, and a straight line that is perpendicular to the connecting line and passes through the second target base point.

Operation 620: Determine a target region center on the rectangular coordinate system.

Operation 630: Acquire the target region based on the target region center.

Operation 610 to operation 630 are described in detail below.

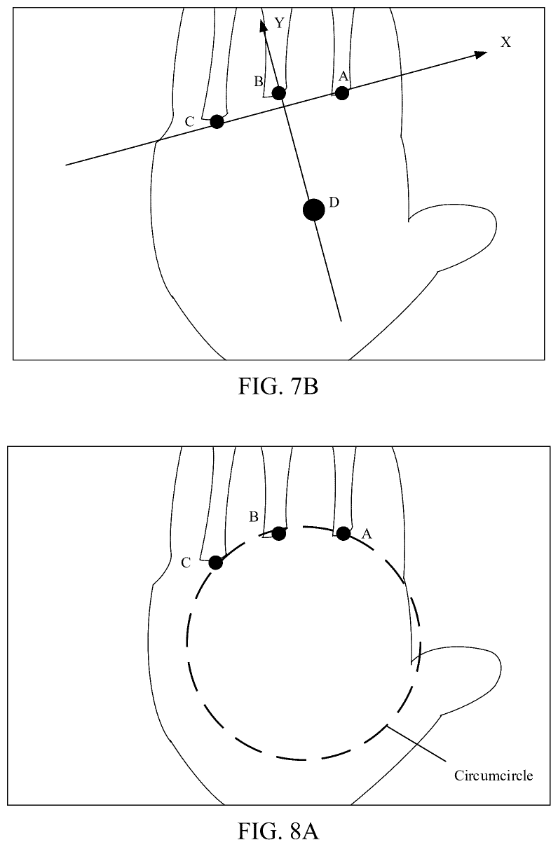

In operation 610, the first target base point is an intersection point of a finger gap between index and middle fingers and the palm, the second target base point is an intersection point of a finger gap between middle and ring fingers and the palm, and the third target base point is an intersection point of a finger gap between ring and little fingers and the palm. For example, referring to FIG. 7A, the first target base point corresponds to a point A, the second target base point corresponds to a point B, and the third target base point corresponds to a point C. A connecting line between the point A and the point C may be a horizontal axis X, and a straight line that is perpendicular to the horizontal axis and passes through the point B is a vertical axis Y A rectangular coordinate system XY shown in FIG. 7A is established based on the horizontal axis X and the vertical axis Y In some embodiments, the connecting line between the point A and the point C may be determined as a vertical axis Y, and a straight line that is perpendicular to the vertical axis and passes through the point B is determined as a horizontal axis X.

In some embodiments, there are a plurality of second target base points, and operation 610 includes:
obtaining a second average target base point based on the plurality of second target base points, a position of the second average target base point being an average value of positions of the plurality of second target base points; and
establishing a rectangular coordinate system based on the connecting line between the first target base point and the third target base point, and a straight line that is perpendicular to the connecting line and passes through the second average target base point.

In some embodiments, the position of the second target base point specifically refers to a position of the second target base point on the target palm image and may be represented as a coordinate position. For example, if there are three second target base points on the target palm image, i.e., (x1, y1), (x2, y2), and (x2, y3), the second average target base point is (x4, y4), x4=(x1+x2+x3)/3, and y4=(y1+y2+y3)/3. After the second average target base point is obtained, the rectangular coordinate system XY shown in FIG. 7A may be obtained in the same manner as the process of establishing the rectangular coordinate system with only one second target base point described above. In some embodiments, the second average target base point is determined based on the plurality of second target base points, and then the rectangular coordinate system is established based on the second average target base point. Therefore, the established rectangular coordinate system is more appropriate and accurate.

Next, in operation 620, the target region center refers to a center point of the target region. Referring to FIG. 7B, there is a point D on the rectangular coordinate system XY, specifically on the target axis (for example, the vertical axis Y) on which the second target base point is located, and the point D is used as the target region center.

Next, in operation 630, the target region may be acquired based on the point D. The target region may be a square or a circle, but it needs to be ensured that the point D is located at the target region center.

An advantage lies in the manner of determining the region center based on three target base points, and then acquiring the target region based on the region center so that the target region is generated around the region center, and the target region is unique. Determining the region center based on a manner of establishing the rectangular coordinate system may improve the accuracy of the determined region center, thereby improving the accuracy of acquiring the target region. In addition, especially when facing palm images of different sizes, or palm images of the same size including palms of different sizes, some embodiments may ensure that the determined target region covers a highly discriminative position in the palm, and the flexibility is relatively high.

Different from the foregoing embodiment in which the region center is determined by establishing the rectangular coordinate system, in another embodiment, the region center may be determined by establishing a circumcircle based on the target base point instead of establishing the rectangular coordinate system based on the target base point.

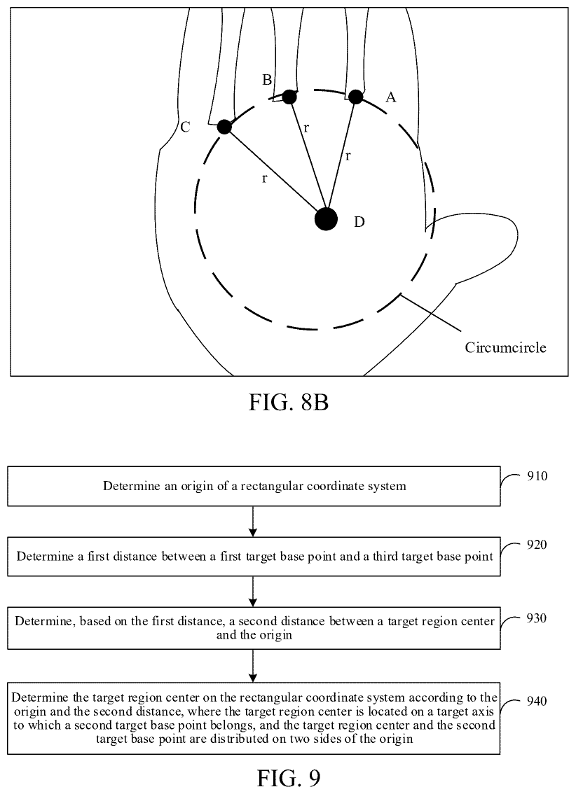

In some embodiments, a circumcircle passing through the first target base point, the second target base point, and the third target base point is acquired. A circle center of the circumcircle is acquired, and the circle center is used as the region center. For example, referring to FIG. 8A, a circumcircle passing through the point A, the point B, and the point C is obtained based on these three points. Referring to FIG. 8B, a distance between each of the point A, the point B, and the point C, and a point D (the point D is the circle center of the circumcircle) is a radius r, and the point D is used as the region center.

An advantage of some embodiments is that the region center is acquired in a circumcircle manner, the processing load is low, and the calculation overhead is small.

Referring to FIG. 9, in some embodiments, operation 620 includes the following operations.

Operation 910: Determine an origin of the rectangular coordinate system.

Operation 920: Determine a first distance between the first target base point and the third target base point.

Operation 930: Determine, based on the first distance, a second distance between the target region center and the origin.

Operation 940: Determine the target region center on the rectangular coordinate system according to the origin and the second distance, where the target region center is located on a target axis to which the second target base point belongs, and the target region center and the second target base point are distributed on two sides of the origin.

Operation 910 to operation 940 are described in detail below.

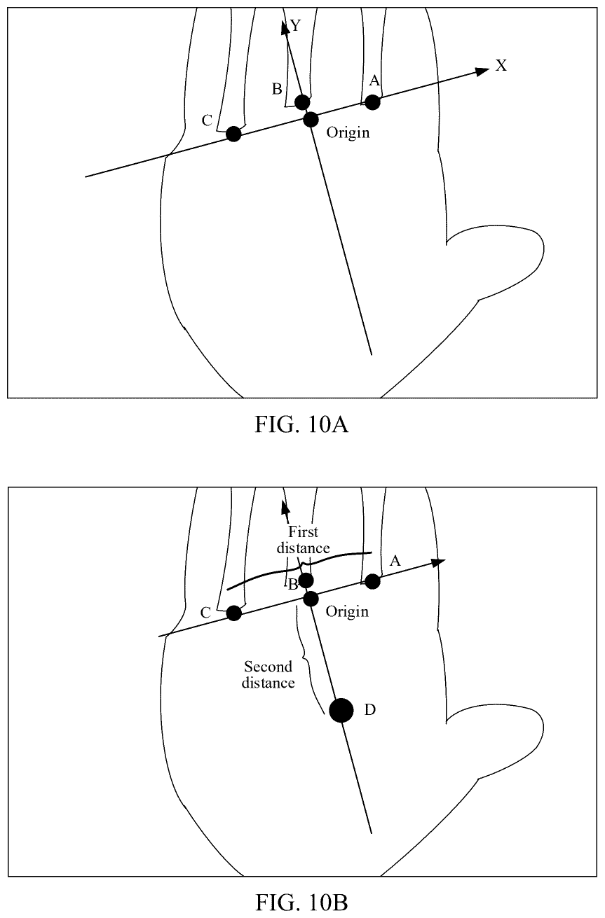

In operation 910, the origin refers to an intersection point of the horizontal axis and the vertical axis in the rectangular coordinate system. For example, as shown in FIG. 10A, an intersection point of a horizontal axis X and a vertical axis Y is the origin.

Next, in operation 920, the first distance refers to a length of a line segment between the first target base point and the third target base point. For example, referring to FIG. 10B, the length of the line segment between the point A and the point C is the first distance.

Next, in operation 930, the second distance refers to a length of a line segment between the target region center and the origin. The second distance is generally obtained by multiplying the first distance by a first coefficient. For example, still referring to FIG. 10B, the length of the line segment between the origin and the point D is the second distance.

FIG. 10B shows a point D at the second distance from the origin on the negative direction side of the Y axis, but actually there is a point at the second distance from the origin on the positive direction side of the Y axis. Therefore, the target region center needs to be selected from the two points. Therefore, in operation 940, the target region center and the second target base point are defined to be distributed on two sides of the origin on the axis. For example, still referring to FIG. 10B, the point B is located on the positive direction side of the Y axis, and the target region point is located on the negative direction side of the Y axis, that is, the point D is used as the target region center.

An advantage of some embodiments is that the second distance is determined according to the first distance so that the distance between the target region center and the origin is closely related to the distance between the first target base point and the third target base point. Such a determining manner may adapt to palm images including different palm sizes, and may further quickly locate the target region center.

In some embodiments, manners of determining the second distance in operation 930 include but are not limited to the following situations.

(1) The first distance is directly used as the second distance.

(2) The first distance is multiplied by a first coefficient to obtain the second distance, where a range of the first coefficient is 0.9 to 1.1.

The following is an example of a comparative experiment between the palm print recognition method according to some embodiments and an existing method on a twin data set.

TABLE 1

| First coefficient | 0.8 | 0.9 | 1 | 1.1 | 1.2 |
|---|---|---|---|---|---|
| Number of incorrect recognition | 80 | 46 | 40 | 47 | 70 |
| sample pairs in Arcface method | | | | | |
| Number of incorrect recognition | 17 | 3 | 0 | 4 | 15 |
| sample pairs in an example | | | | | |
| embodiment | | | | | |

As shown in Table 1, palm images of forty pairs of twins are used in the comparative experiment as highly similar palm image pairs for testing. The left hands/right hands of the same pair of twins are used as one sample pair, containing a total of 3,600 sample pairs. On the premise that the first coefficients are the same, the number of incorrect recognition sample pairs in an example embodiment is less than the number of incorrect recognition sample pairs in the most advanced Arcface method in the existing method. For example, when the first coefficient is 1, the number of incorrect recognition sample pairs in an example embodiment is 0, and the number of incorrect recognition sample pairs in the Arcface method is 40. It can be learned that in an example embodiment, the recognition accuracy of highly similar sample pairs is higher.

Still as shown in Table 1, on the premise that the first coefficients are different, the number of incorrect recognition sample pairs in an example embodiment is different. When the first coefficient is 0.8, the number of incorrect recognition sample pairs is 17. When the first coefficient is 0.9, the number of incorrect recognition sample pairs is 3. When the first coefficient is 1, the number of incorrect recognition sample pairs is 0. When the first coefficient is 1.1, the number of incorrect recognition sample pairs is 4. When the first coefficient is 1.2, the number of incorrect recognition sample pairs is 15. It can be learned that, to satisfy high requirements of some application scenes (such as the mobile payment scene) on the recognition accuracy, a range of the first coefficient may be set to 0.9 to 1.1, and preferably, the first coefficient is 1.

For decomposition of operation 630, some embodiments provide two decomposition manners. In each decomposition manner, detailed descriptions of operation 630 are provided from different perspectives. A first decomposition manner is first described.

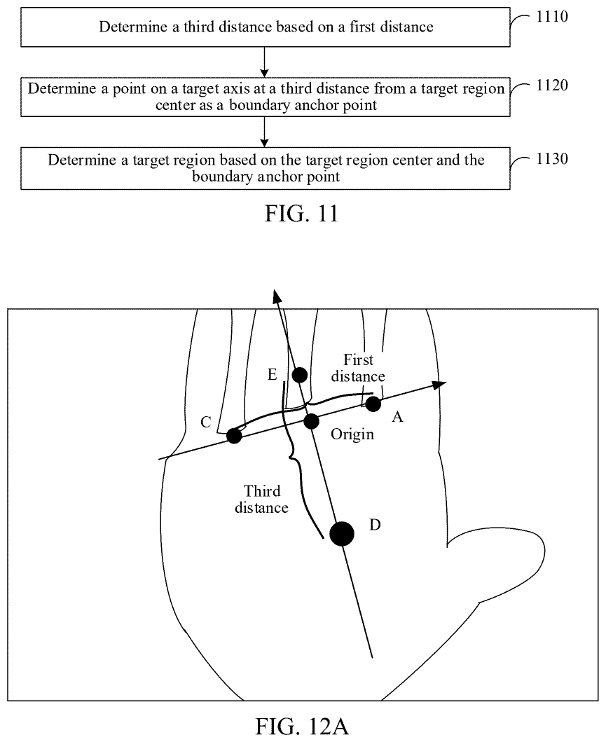

Referring to FIG. 11, in some embodiments, the target region is a square, and operation 630 includes the following operations.

Operation 1110: Determine a third distance based on the first distance.

Operation 1120: Determine a point on the target axis at the third distance from the target region center as a boundary anchor point.

Operation 1130: Determine the target region based on the target region center and the boundary anchor point.

Operation 1110 to operation 1130 are described in detail below.

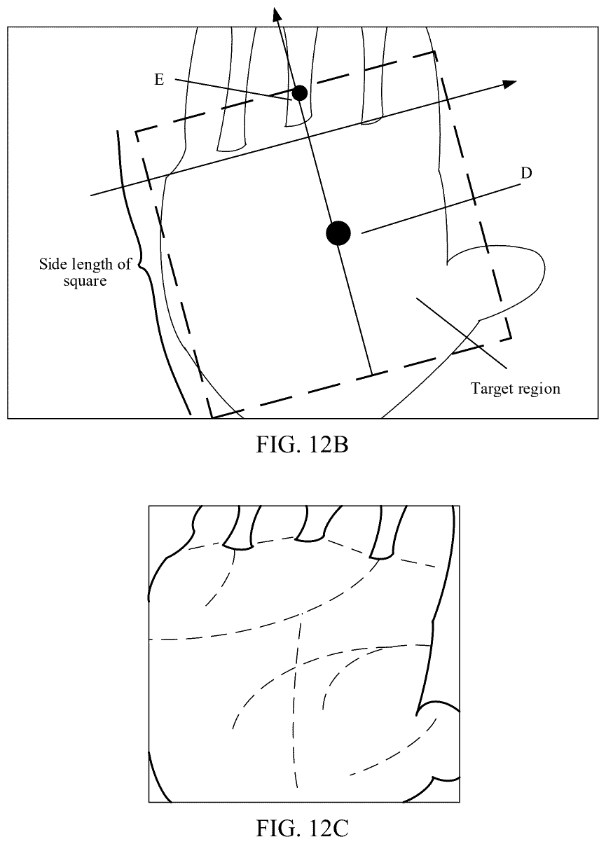

In operation 1110, the first distance represents a length of a line segment between the first target base point and the third target base point. Therefore, the third distance is closely related to a position of the first target base point and a position of the third target base point. For example, referring to FIG. 12A, a length of a line segment between a point A and a point C is the first distance, and then the third distance may be obtained by multiplying the first distance by a second coefficient.

Next, in operation 1120, the boundary anchor point refers to a point through which the boundary of the target region passes. For example, still referring to FIG. 12A, there is a point E on the Y axis, and a length of a line segment between the point E and the point D is the third distance. Therefore, the point E is determined as the boundary anchor point. The point E shown in FIG. 12A is located on a positive direction side of the target region center, but actually, the point E may be located on a negative direction side of the target region center.

Next, in operation 1130, the target region center is used as a center point of the target region, and a side length of the square may be determined according to a distance between the target region center and the boundary anchor point. The target region having a square shape may be determined based on the center point, the side length of the square, and the boundary anchor point. Referring to FIG. 12B, as shown in FIG. 12B, a region in a dashed box on the target palm image is the target region, and a shape of the dashed box is a square. Therefore, the shape of the target region is a square. Referring to FIG. 12C, FIG. 12C shows a complete target region. The target region shown in FIG. 12C is the same as the region in the dashed box in FIG. 12B, except that palm print lines in the target region are specifically shown in FIG. 12C, but palm print lines in FIG. 12B are omitted. Similarly, in other palm images shown in some embodiments, palm print lines of some palm images are also omitted. However, actually, similar to FIG. 12C, palm print lines exist in palm regions of the palm images.

An advantage of some embodiments is that the third distance is determined through the first distance, and then the boundary anchor point is determined through the third distance so that the side length of the target region is closely related to the distance between the first target base point and the third target base point, and a coverage range of the target region is closely related to the first target base point and the third target base point, thereby ensuring the uniqueness of the target region. In addition, in addition to ensuring that the target region contains a highly discriminative palm region, it is possible to reduce the possibility that the target region contains a less discriminative palm region. In this way, not only the flexibility of generating the target region can be improved, but also the processing resources for the target region can be saved, thereby further improving the palm print recognition efficiency.

In some embodiments, manners of determining the third distance in operation 1110 include but are not limited to the following situations.

(1) The first distance is directly used as the third distance.

(2) The first distance is multiplied by a second coefficient to obtain the third distance, where a range of the second coefficient is 0.65 to 0.85.

The following is an example of a comparative experiment between the palm print recognition method according to some embodiments and an existing method on a twin data set.

TABLE 2

| Second coefficient | 0.55 | 0.65 | 0.75 | 0.85 | 0.95 |
|---|---|---|---|---|---|
| Number of incorrect | 70 | 45 | 37 | 42 | 75 |
| recognition sample pairs in | | | | | |
| Arcface method | | | | | |
| Number of incorrect | 13 | 3 | 0 | 2 | 17 |
| recognition sample pairs in an | | | | | |
| example embodiment | | | | | |

As shown in Table 2, palm images of forty pairs of twins are used in the comparative experiment as highly similar palm image pairs for testing. The left hands/right hands of the same pair of twins are used as one sample pair, containing a total of 3,600 sample pairs. On the premise that the second coefficients are the same, the number of incorrect recognition sample pairs in an example embodiment is less than the number of incorrect recognition sample pairs in the Arcface method. For example, when the second coefficient is 0.75, the number of incorrect recognition sample pairs in an example embodiment is 0, and the number of incorrect recognition sample pairs in the Arcface method is 37. It can be learned that in an example embodiment, the recognition accuracy of highly similar sample pairs is higher.

Still as shown in Table 2, on the premise that the second coefficients are different, the number of incorrect recognition sample pairs in an example embodiment is different. When the second coefficient is 0.55, the number of incorrect recognition sample pairs is 13. When the second coefficient is 0.65, the number of incorrect recognition sample pairs is 3. When the second coefficient is 0.75, the number of incorrect recognition sample pairs is 0. When the second coefficient is 0.85, the number of incorrect recognition sample pairs is 2. When the second coefficient is 0.95, the number of incorrect recognition sample pairs is 17. It can be learned that, to satisfy high requirements of some application scenes (such as the mobile payment scene) on the recognition accuracy, a range of the second coefficient may be set to 0.65 to 0.85, and preferably, the second coefficient is 0.75.

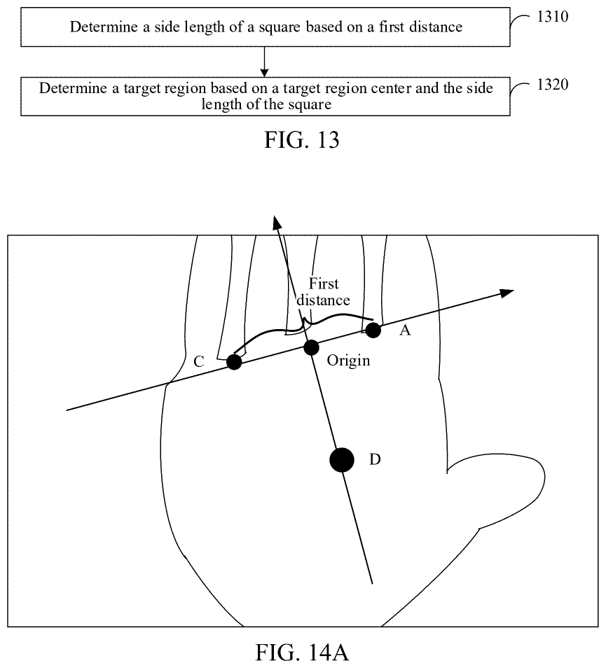

Referring to FIG. 13, in some embodiments, the target region is a square, and operation 630 includes the following operations.

Operation 1310: Determine a side length of the square based on the first distance.

Operation 1320: Determine the target region based on the target region center and the side length of the square.

Operation 1310 to operation 1320 are described in detail below.

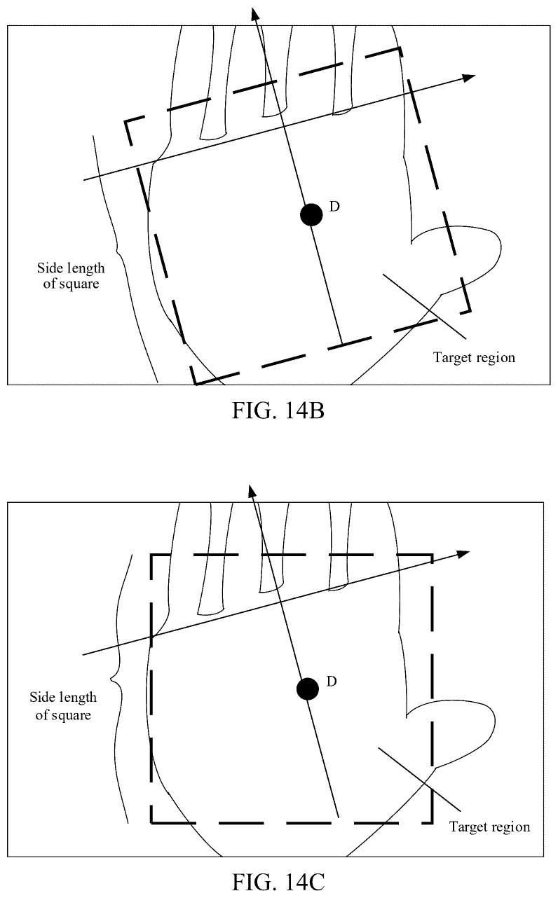

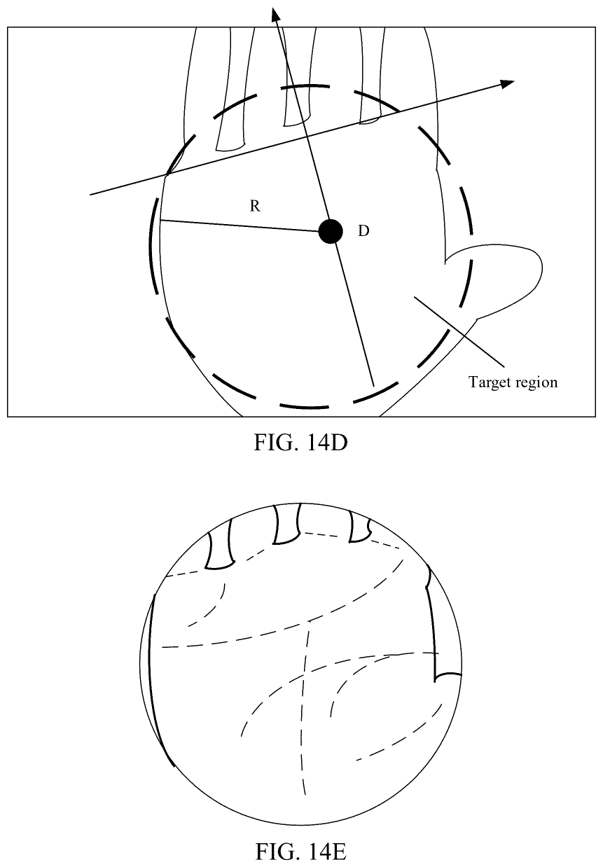

In operation 1310, the first distance represents a length of a line segment between the first target base point and the third target base point. Therefore, the side length of the square is closely related to a position of the first target base point and a position of the third target base point. For example, referring to FIG. 14A, a length of a line segment between a point A and a point C is the first distance, and the side length of the square may be determined according to the first distance.

In operation 1320, the target region may be generated using the target region center as the center of the target region and using the side length of the square as the side length of the target region. Referring to FIG. 14B, FIG. 14B shows a target region that is perpendicular or parallel to a coordinate axis of the rectangular coordinate system (the target region is represented by a black thick dashed line box). Referring to FIG. 14C, FIG. 14C shows a target region that is not perpendicular or parallel to a coordinate axis of the rectangular coordinate system (the target region is represented by a black thick dashed line box).

An advantage of some embodiments is that the side length of the square is determined through the first distance so that the side length of the target region is closely related to the first target base point and the third target base point, and a coverage range of the target region is not limited.

In the foregoing embodiment, the target region is defined as a square, but in another embodiment, the target region may be a circle.

In some embodiments, operation 630 includes the following operations:
determining a circle radius based on the first distance; and
generating the target region based on the target region center and the circle radius.

For example, referring to FIG. 14D, the circle radius is R, and R may be equal to the first distance * a radius coefficient. The radius coefficient may be set according to requirements. As shown in FIG. 14D, the target region may be generated on the target palm image using the target region center as a circle center and R as a radius (the target region is represented by a black thick dashed line box). Referring to FIG. 14E, FIG. 14E shows a complete target region. The target region shown in FIG. 14E is the same as the region in the dashed box in FIG. 14D, except that palm print lines in the target region are specifically shown in FIG. 14E, but palm print lines in FIG. 14D are omitted.

An advantage of some embodiments is similar to those of operation 1310 to operation 1330, except that the shape of the target region in some embodiments is a circle, and the shape of the target region in operation 1310 to operation 1330 is a square. Since determining a circular region only needs to determine a circle center and a radius, the processing overhead is reduced, and the processing efficiency is improved.

In some embodiments, manners of determining the side length of the square in operation 1310 include but are not limited to the following situations.

(1) The first distance is directly used as the side length of the square.

(2) The first distance is multiplied by a third coefficient to obtain the side length of the square, where a range of the third coefficient is 1.3 to 1.7.

The following is an example of a comparative experiment between the palm print recognition method according to some embodiments and an existing method on a twin data set.

TABLE 3

| Third coefficient | 1.1 | 1.3 | 1.5 | 1.7 | 1.9 |
|---|---|---|---|---|---|
| Number of incorrect recognition | 73 | 47 | 38 | 44 | 78 |
| sample pairs in Arcface method | | | | | |
| Number of incorrect recognition | 19 | 4 | 0 | 3 | 21 |
| sample pairs in an example | | | | | |
| embodiment | | | | | |

As shown in Table 3, palm images of forty pairs of twins are used in the comparative experiment as highly similar palm image pairs for testing. The left hands/right hands of the same pair of twins are used as one sample pair, containing a total of 3,600 sample pairs. On the premise that the third coefficients are the same, the number of incorrect recognition sample pairs in an example embodiment is less than the number of incorrect recognition sample pairs in the Arcface method. For example, when the second coefficient is 1.5, the number of incorrect recognition sample pairs in an example embodiment is 0, and the number of incorrect recognition sample pairs in the Arcface method is 38. It can be learned that in an example embodiment, the recognition accuracy of highly similar sample pairs is higher.

Still as shown in Table 3, on the premise that the third coefficients are different, the number of incorrect recognition sample pairs in an example embodiment is different. When the third coefficient is 1.1, the number of incorrect recognition sample pairs is 19. When the third coefficient is 1.3, the number of incorrect recognition sample pairs is 4. When the third coefficient is 1.5, the number of incorrect recognition sample pairs is 0. When the third coefficient is 1.7, the number of incorrect recognition sample pairs is 3. When the third coefficient is 1.9, the number of incorrect recognition sample pairs is 21. It can be learned that, to satisfy high requirements of some application scenes (such as the mobile payment scene) on the recognition accuracy, a range of the third coefficient may be set to 1.3 to 1.7, and preferably, the third coefficient is 1.5.

It may be found by comparing Table 3 with Table 2 that when the third coefficient is twice the second coefficient, the target region generated in operation 1110 to operation 1130 and the target region generated in operation 1310 to operation 1320 are equal in side length and both are squares. However, in the embodiment of operation 1110 to operation 1130, the number of incorrect recognition sample pairs is less than that in the embodiment of operation 1310 to operation 1320. For example, when the second coefficient is 0.65, and the third coefficient is 1.3, the number of incorrect recognition sample pairs in the embodiment of operation 1110 to operation 1130 is 3, and the number of incorrect recognition sample pairs in the embodiment of operation 1310 to operation 1320 is 4. For another example, when the second coefficient is 0.85, and the third coefficient is 1.7, the number of incorrect recognition sample pairs in the embodiment of operation 1110 to operation 1130 is 2, and the number of incorrect recognition sample pairs in the embodiment of operation 1310 to operation 1320 is 3. This is because, when the target region is generated through operation 1310 to operation 1330, the boundary anchor point is first determined on the target axis based on the first distance, and then the target region is generated based on the boundary anchor point and the target region center. Such a generation manner may reduce uncertainty when the target region is generated, thereby helping improve the recognition accuracy.

In operation 330, the plurality of target sub-regions are determined in the target region, and the plurality of target sub-regions do not overlap with each other.

For decomposition of operation 330, some embodiments provide two specific implementations. In each specific implementation, detailed descriptions of operation 330 are provided from different perspectives. A first specific implementation is first described.

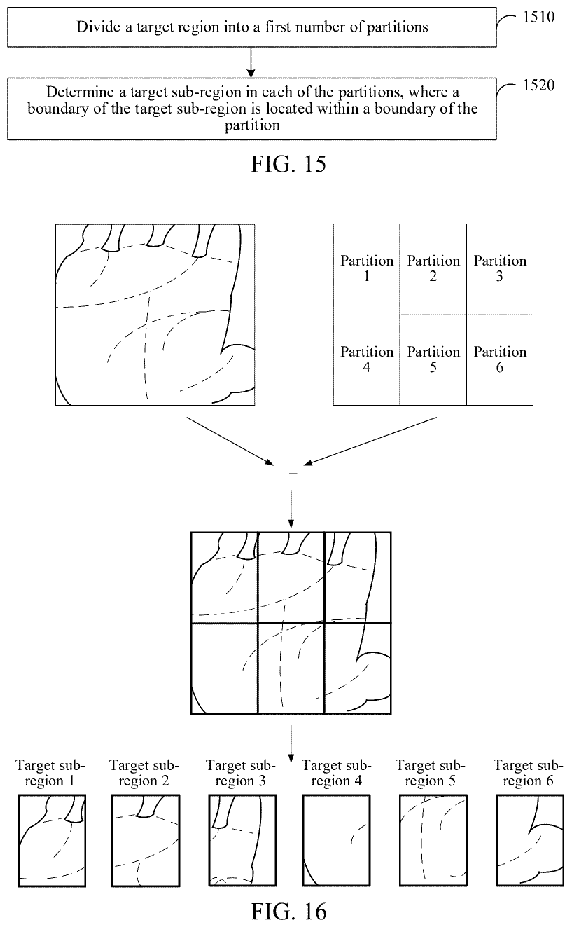

Referring to FIG. 15, in some embodiments, the plurality of target sub-regions are a first number of target sub-regions, and operation 330 includes the following operations.

Operation 1510: Divide the target region into the first number of partitions.

Operation 1520: Determine a target sub-region in each of the partitions, where a boundary of the target sub-region is located within a boundary of the partition.

Operation 1510 to operation 1520 are described in detail below.

In operation 1510, the partition refers to a part of the target region, and the partitions do not overlap with each other. The first number is an integer greater than 1. Dividing the target region into the first number of partitions is equivalent to dividing the target region into a first number of parts, and each part is used as a partition. The first number may be set according to actual requirements. For example, referring to FIG. 16, the first number is 6, and the target region is divided into 6 partitions, including a partition 1, a partition 2, a partition 3, a partition 4, a partition 5, and a partition 6. As shown in FIG. 16, the target region is evenly divided into 6 partitions. Sizes of the partitions shown in FIG. 16 are the same, but the sizes of the partitions may be different in other embodiments.

In operation 1520, a target sub-region is determined in each of the partitions, and the boundary of the target sub-region is located within the boundary of the partition. In this way, since the partitions do not overlap with each other, the generated target sub-regions do not overlap with each other.

In an example, still referring to FIG. 16, a target sub-region 1 is determined in the partition 1, a target sub-region 2 is determined in the partition 2, a target sub-region 3 is determined in the partition 3, a target sub-region 4 is determined in the partition 4, a target sub-region 5 is determined in the partition 5, and a target sub-region 6 is determined in the partition 6. The size of each target sub-region shown in FIG. 16 is the same as that of a corresponding partition (for example, a size of the target sub-region 1 is the same as that of the partition 1), but the size of the target sub-region may be different from that of a corresponding partition in another embodiment.

An advantage of some embodiments is that the target region is first divided into partitions, and then the target sub-regions are generated based on the partitions so that a plurality of target sub-regions may be rapidly generated, and it may be ensured that the plurality of target sub-regions do not overlap with each other, leading to a relatively high generation efficiency.

In some embodiments, the first number in operation 1510 is determined by the following manners:
acquiring a resolution of a target palm image;
acquiring palm print recognition precision; and
determining the first number based on the resolution and the precision.

In some embodiments, manners of acquiring the resolution of the target palm image include but are not limited to the following situations.

(1) A horizontal resolution of the target palm image in a horizontal direction and a vertical resolution of the target palm image in a vertical direction are counted, and the resolution of the target palm image is obtained according to the horizontal resolution and the vertical resolution. For example, if the horizontal resolution is 310 pixels, and the vertical resolution is 460 pixels, the resolution is 310×460 pixels.

(2) A size of the target palm image is acquired and used as a resolution. For example, if the size of the target palm image is 3,840×2,400, the resolution is 3,840×2,400 pixels.

In addition to acquiring the resolution, the palm print recognition precision also needs to be acquired. The palm print recognition precision represents a requirement on accuracy of a palm print recognition result, and the precision is set according to actual requirements. In some scenes that have a high requirement on the accuracy of the palm print recognition result, the palm print recognition precision is also relatively high. For example, in the mobile payment scene, the requirement on the accuracy is extremely high, and therefore, the palm print recognition precision is set to be relatively high. For another example, in a scene of clocking in and out for work, the requirement on the accuracy is not high, and therefore, the palm print recognition precision may be set to be relatively low.

After the resolution and the precision are obtained, the first number may be determined. Specifically, the higher the resolution, the clearer each pixel. The target sub-region does not need to have too many pixels, and the first number may be set to be relatively large. The lower the resolution, the blurrier each pixel. A larger target sub-region is needed, and the first number may be set to be relatively small. In addition, the higher the requirement on the accuracy, the more target sub-regions are needed, and the first number may be set to be relatively large.

An advantage of some embodiments is that the resolution and the precision jointly determine the first number, the factors considered are comprehensive, and the rationality of the number of target sub-regions is improved, thereby improving the palm print recognition accuracy.

In some embodiments, determining the first number based on the resolution and the precision includes:
determining a first score based on the resolution;
determining a second score based on the precision;
determining a total score based on the first score and the second score; and
determining the first number based on the total score.

Determining the first score based on the resolution may be performed by querying a comparison table of the resolution and the first score, a formula method, or the like.

(1) The comparison table of the resolution and the first score lists a correspondence between a resolution range and the first score. A horizontal resolution and a vertical resolution are first obtained according to the target palm image, a resolution range to which a product of the horizontal resolution and the vertical resolution belongs is determined, and then the first score is obtained by looking up the comparison table of the resolution range and the first score according to the resolution range. The following Table 4 is an example of a comparison table of the resolution range and the first score.

TABLE 4

| Resolution range | First score |
|---|---|
| Above 1 million pixels | 100 |
| 0.8-1 million pixels | 90 |
| 0.5-0.8 million pixels | 80 |
| 0.2-0.5 million pixels | 70 |
| 0.1-0.2 million pixels | 60 |
| . . . | . . . |

For example, the resolution of the target palm image is 800×600 pixels, a product of 800 and 600 yields 0.48 million pixels, and the corresponding first score is 70 by looking up Table 4.

The foregoing manner of looking up the comparison table of the resolution range and the first score has advantages of simplicity and low processing overheads.

(2) When the formula method is used, the first score may be set to be proportional to the resolution, for example:

$$Q 1 = K 1 \cdot G 1 , \qquad Formula 1$$

where Q1 represents the first score, G1 represents the product of the horizontal resolution and the vertical resolution, and K1 is a preset constant and may be set according to actual needs. For example, K1=35/24, and after G1=48 is substituted into the formula, the first score is Q1=70.

The foregoing manner of determining the first score through a formula has an advantage of high precision, and the formula can be adjusted as required and has high flexibility.

Determining the second score based on the precision may be performed by querying a comparison table of the precision and the second score, a formula method, or the like.

(1) The comparison table of the precision and the second score lists a correspondence between a precision range and the second score. A precision range to which the precision belongs is first determined, and then the second score is obtained by looking up the comparison table of the precision range and the second score according to the precision range. The following Table 5 is an example of a comparison table of the precision range and the second score.

TABLE 5

| Precision range | Second score |
|---|---|
| Above 95% | 100 |
| 90%-95% | 90 |
| 80%-90% | 80 |
| 70%-80% | 70 |
| 60%-70% | 60 |
| . . . | . . . |

For example, the palm print recognition precision is 92%, and the corresponding second score is 90 by looking up Table 5.

The foregoing manner of looking up the comparison table of the precision range and the second score has advantages of simplicity and low processing overheads.

(2) When the formula method is used, the second score may be set to be proportional to the precision, for example:

$$Q 2 = K 2 \cdot G 2 , \qquad Formula 2$$

where Q2 represents the second score, G2 represents the precision, and K2 is a preset constant and may be set according to actual needs. For example, K2=45/46, and after G2=92 is substituted into the formula, the second score is Q2=90.

The foregoing manner of determining the second score through a formula has an advantage of high precision, and the formula can be adjusted as required and has high flexibility.

Determining the total score based on the first score and the second score may be performed by calculating an average or a weighted average of the first score and the second score.

When the average of the first score and the second score is calculated as the total score, for example, the first score of the target palm image is 70, and the second score is 90 so that the total score is (70+90)/2=80. An advantage of calculating the total score using the average is that the effect of the resolution and the precision on the first number may be equally reflected.

When the weighted average of the first score and the second score is calculated as the total score, for example, weights of the first score determined according to the resolution and the second score determined according to the precision are set to 0.6 and 0.4, respectively, the first score of the target palm image is 70, and the second score is 90 so that the total score is 70×0.6+90×0.4=78. An advantage of calculating the total score using the weighted average is that different weights can be set for the resolution and the precision, thereby improving the flexibility of determining the first number.

Determining the first number based on the total score may be performed by querying a comparison table of the total score and the first number, a formula method, or the like.

(1) The first number may be obtained by looking up the comparison table of the total score and the first number according to the total score (the comparison table of the total score and the first number lists a correspondence between the total score and a preset order). The following Table 6 is an example of a comparison table of the total score and the first number.

TABLE 6

| Total score range | First number |
|---|---|
| Above 90 | 10 |
| 80-89 | 9 |
| 70-79 | 8 |
| 60-69 | 7 |
| 50-59 | 6 |
| . . . | . . . |

It is assumed that the total score of the target palm image is 80, and the corresponding first number is 9 by looking up 6.

The foregoing manner of looking up the comparison table of the total score and the first number has advantages of simplicity and low processing overheads.

(2) When the formula method is used, the first number may be set to be proportional to the total score, for example:

$$T = K 3 \cdot Q 3 , \qquad Formula 3$$

where T represents the first number, Q3 represents the total score, and K3 is a preset constant and may be set according to actual needs. For example, K3=9/80, and after Q3=80 is substituted into the formula, T=9.

The foregoing manner of determining the order through a formula has an advantage of high precision, and the formula can be adjusted as required and has high flexibility.

An advantage of some embodiments is that the first score corresponding to the resolution and the second score corresponding to the precision are separately calculated, and then the first number is determined so that the flexibility and correctness of determining the first number may be improved.

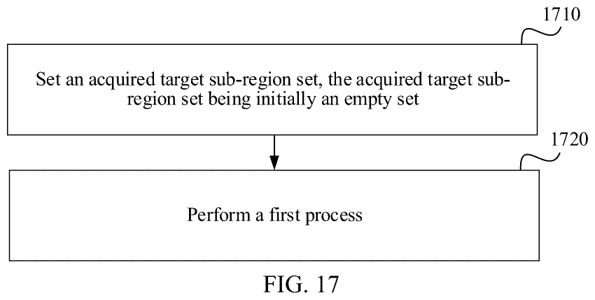

Referring to FIG. 17, in some embodiments, the target sub-region is a rectangle, the plurality of target sub-regions are a second number of target sub-regions, and operation 340 includes the following operations.

Operation 1710: Set an acquired target sub-region set, the acquired target sub-region set being initially an empty set.

Operation 1720: Perform a first process.

Operation 1710 to operation 1720 are described in detail below.

In operation 1710, the acquired target sub-region set refers to a storage container that is set in advance and configured to store data related to the target sub-region. The acquired target sub-region set is initially an empty set. The acquired target sub-region set may store related data of a plurality of target sub-regions, but the plurality of target sub-regions do not overlap with each other.

In operation 1720, the first process needs to be cyclically performed to store related data of the second number of target sub-regions to the acquired target sub-region set. The first process includes: selecting a target sub-region basis point from a range that is in the target region and not covered by target sub-regions in the acquired target sub-region set; acquiring a first length and a second length; determining, based on the target sub-region basis point, the target sub-region using the first length as a length of the target sub-region and the second length as a width of the target sub-region; adding, if a determined target sub-region does not overlap with any target sub-region in the acquired target sub-region set, the target sub-region to the acquired target sub-region set; otherwise, deleting the target sub-region; and repeatedly performing the first process until the number of target sub-regions in the acquired target sub-region set reaches the second number.

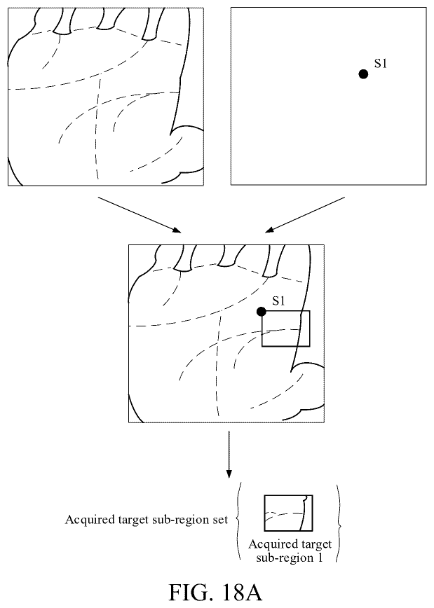

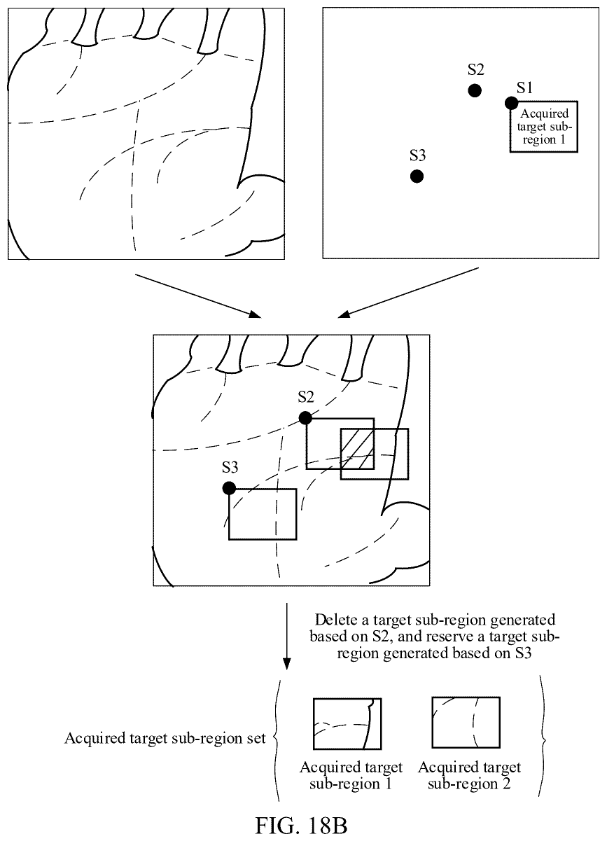

The first process is described in detail below with reference to FIG. 18A and FIG. 18B. Repeatedly performing the first process specifically includes the following operations.

(1) Referring to FIG. 18A, since the acquired target sub-region set is initially empty, in this case, a target sub-region basis point, for example, a point S1, may be randomly selected from the target region. The first length and the second length are acquired, and a target sub-region is determined based on the point S1, the first length, and the second length. In this case, the acquired target sub-region set is empty, and therefore, the target sub-region does not overlap with any target sub-region in the acquired target sub-region set. Therefore, the target sub-region is used as an acquired target sub-region 1 and added to the acquired target sub-region set. In this case, the acquired target sub-region set stores related data of the acquired target sub-region 1, for example, data indicating a position of the target sub-region 1.

(2) Referring to FIG. 18B, a target sub-region basis point, for example, a point S2, is selected from a range that is in the target region and not covered by the acquired target sub-region 1. The first length and the second length are acquired, and a target sub-region is determined based on the point S2, the first length, and the second length. The target sub-region determined based on the point S2 overlaps with the acquired target sub-region 1 (for example, black oblique lines between two rectangular boxes shown in FIG. 18B). Therefore, the target sub-region determined based on the point S2 is deleted. In this case, the acquired target sub-region set still stores only the related data of the acquired target sub-region 1.

(3) Still referring to FIG. 18B, a target sub-region basis point, for example, a point S3, is selected from a range that is in the target region and not covered by the acquired target sub-region 1. The first length and the second length are acquired, and a target sub-region is determined based on the point S3, the first length, and the second length. The target sub-region does not overlap with the acquired target sub-region 1. Therefore, the target sub-region determined based on the point S3 is used as an acquired target sub-region 2 and added to the acquired target sub-region set. In this case, the acquired target sub-region set stores related data of the acquired target sub-region 1 and the acquired target sub-region 2. If the second number is 2, the number of acquired target sub-regions in the acquired target sub-region set reaches the second number, and the first process may be exited.

An advantage of some embodiments is that by setting the acquired target sub-region set, each time a target sub-region is determined, the target sub-region may be compared with the acquired target sub-region, and then whether to reserve the target sub-region is selected based on a comparison result, thereby ensuring that the acquired target sub-regions do not overlap with each other, and improving the acquisition efficiency.

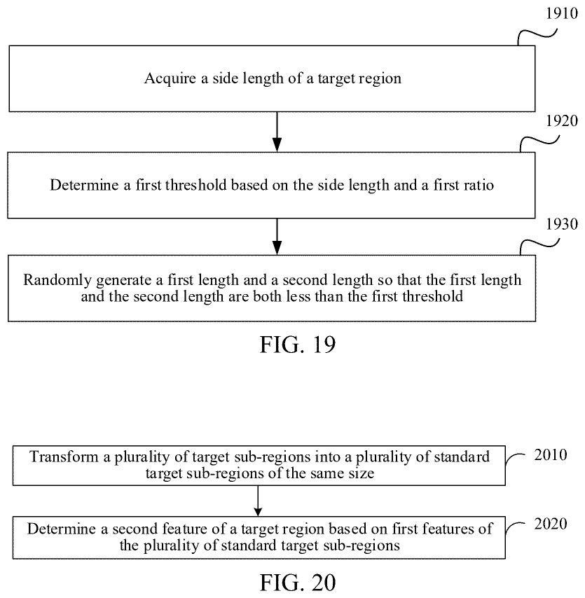

Referring to FIG. 19, in some embodiments, acquiring the first length and the second length in the foregoing first process includes the following operations.

Operation 1910: Acquire a side length of the target region.

Operation 1920: Determine a first threshold based on the side length and a first ratio.

Operation 1930: Randomly generate a first length and a second length so that the first length and the second length are both less than the first threshold.

Operation 1910 to operation 1930 are described in detail below.

In operation 1910, the side length refers to a length of a boundary of the target region. If the target region is a rectangle, the side length may be a length or a width of the rectangle. If the target region is a circle, the side length refers to a diameter of the target region.

In operation 1920, the side length may be multiplied by the first ratio to obtain the first threshold. For example, if the side length is 9, and the first ratio is 1/3, the first threshold is 3.

In operation 1930, the first length and the second length may be generated based on a random function, but the first length and the second length are both less than the first threshold. For example, the first length is randomly generated to be 4, and the second length is randomly generated to be 2. Since the first length is greater than the first threshold, the first length is deleted. The first length may be randomly generated to be 3. Since the first length and the second length are both less than the first threshold, it is obtained that the first length is 3, and the second length is 2.

An advantage of some embodiments is that by limiting the first length and the second length, it may be ensured that the second number of target sub-regions can be generated in the target region during execution of the first process.

In some embodiments, a range of the first ratio in operation 1920 is 1/4 to 5/12. Preferably, the first ratio is 1/3. The following Table 7 is an example of a comparative experiment between the palm print recognition method according to some embodiments and an existing method on a twin data set.

TABLE 7

| First ratio | 1/6 | 1/4 | 1/3 | 5/12 | 1/2 |
|---|---|---|---|---|---|
| Number of incorrect recognition | 78 | 41 | 30 | 43 | 73 |
| sample pairs in Arcface method | | | | | |
| Number of incorrect recognition | 22 | 5 | 0 | 6 | 28 |
| sample pairs in an example | | | | | |
| embodiment | | | | | |

As shown in Table 7, palm images of forty pairs of twins are used in the comparative experiment as highly similar palm image pairs for testing. The left hands/right hands of the same pair of twins are used as one sample pair, containing a total of 3,600 sample pairs. On the premise that the first ratios are the same, the number of incorrect recognition sample pairs in an example embodiment is less than the number of incorrect recognition sample pairs in the Arcface method. For example, when the first ratio is 1/3, the number of incorrect recognition sample pairs in an example embodiment is 0, and the number of incorrect recognition sample pairs in the Arcface method is 30. It can be learned that in an example embodiment, the recognition accuracy of highly similar sample pairs is higher.

Still as shown in Table 7, on the premise that the first ratios are different, the number of incorrect recognition sample pairs in an example embodiment is different. When the first ratio is 1/6, the number of incorrect recognition sample pairs is 22. When the first ratio is 1/4, the number of incorrect recognition sample pairs is 5. When the first ratio is 1/3, the number of incorrect recognition sample pairs is 0. When the first ratio is 5/12, the number of incorrect recognition sample pairs is 6. When the first ratio is 1/2, the number of incorrect recognition sample pairs is 28. It can be learned that, to satisfy high requirements of some application scenes (such as the mobile payment scene) on the recognition accuracy, a range of the first ratio may be set to 1/4 to 5/12, and preferably, the first ratio is 1/3.

In operation 340, the second feature of the target region is determined based on the first features of the plurality of target sub-regions.

Referring to FIG. 20, in some embodiments, operation 340 includes the following operations.

Operation 2010: Transform the plurality of target sub-regions into a plurality of standard target sub-regions of the same size.

Operation 2020: Determine the second feature of the target region based on first features of the plurality of standard target sub-regions.

Operation 2010 to operation 2020 are described in detail below.

In operation 2010, sizes of the plurality of target sub-regions are not necessarily the same, but uncertainty may be caused when the first features are extracted from the target sub-regions of different sizes. Therefore, size transformation needs to be performed to transform the plurality of target sub-regions into the same size to obtain the standard target sub-regions.

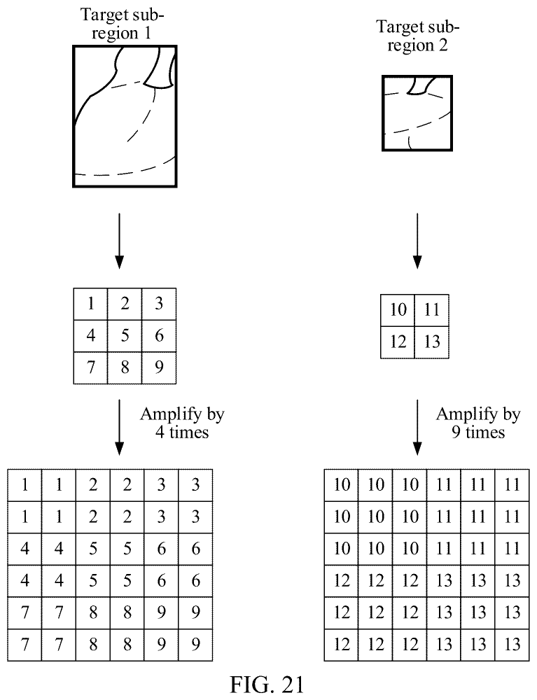

For example, referring to FIG. 21, FIG. 21 shows a size transformation process of two target sub-regions having different sizes. As shown in FIG. 21, sizes of the target sub-region 1 and the target sub-region 2 are different, and the size of the target sub-region 1 is larger than the size of the target sub-region 2. For ease of understanding, the target sub-region 1 is represented as 3×3 pixels, and pixels in the target sub-region 1 are represented using the numbers 1 to 9. The target sub-region 2 is represented as 2×2 pixels, and pixels in the target sub-region 2 are represented using the numbers 10 to 13. Pixels 1 to 13 are used as examples of pixels and do not represent real pixel values. It can be learned that the size of the target sub-region 1 is represented as 3×3, and the size of the target sub-region 2 is represented as 2×2.

Still referring to FIG. 21, it is assumed that a standard target size is 6×6, each pixel in the target sub-region 1 is amplified by 4 times, and a size of a standard target sub-region 1 is 6×6. If each pixel in the target sub-region 2 is amplified by 9 times, a size of a standard target sub-region 2 is 6×6. The magnification is related to the target size and the size of the target sub-region.

The nearest interpolation method is adopted in FIG. 21, and therefore, each pixel is uniformly amplified several times. However, in other embodiments, other amplification manners may be adopted, for example, a bilinear interpolation method.

After the plurality of standard target sub-regions are obtained, in operation 2020, the second feature of the target region is determined based on the first features of the plurality of standard target sub-regions.

An advantage of some embodiments is that when the first feature is extracted, the first feature is extracted from a plurality of standard target sub-regions having the same size so that the uncertainty of feature extraction may be reduced, thereby helping improve the feature extraction efficiency and the palm print recognition accuracy.

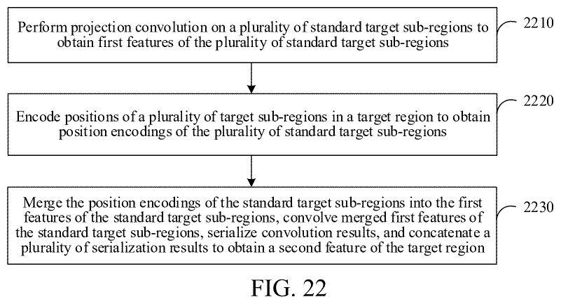

Referring to FIG. 22, in some embodiments, operation 2020 includes the following operations.

Operation 2210: Perform projection convolution on the plurality of standard target sub-regions to obtain the first features of the plurality of standard target sub-regions.

Operation 2220: Encode positions of the plurality of target sub-regions in the target region to obtain position encodings of the plurality of standard target sub-regions.

Operation 2230: Merge the position encodings of the standard target sub-regions into the first features of the standard target sub-regions, convolve merged first features of the standard target sub-regions, serialize convolution results, and concatenate a plurality of serialization results to obtain the second feature of the target region.

Operation 2210 to operation 2230 are described in detail below.

In operation 2210, projection convolution is to perform dimension reduction on an inputted standard target sub-region using a fixed convolution block. A convolution block refers to a module that performs a convolution calculation. Each convolution block (referred to as a convolution block) includes a convolution layer, a normalization layer (referred to as a layernorm layer), and an activation layer (for example, a relu activation layer). One or more convolution blocks may be cascaded to obtain a projection convolution model, and the projection convolution model performs projection convolution on the inputted standard target sub-region. For example, the projection convolution model may include two convolution blocks. The projection convolution model is described in detail below.

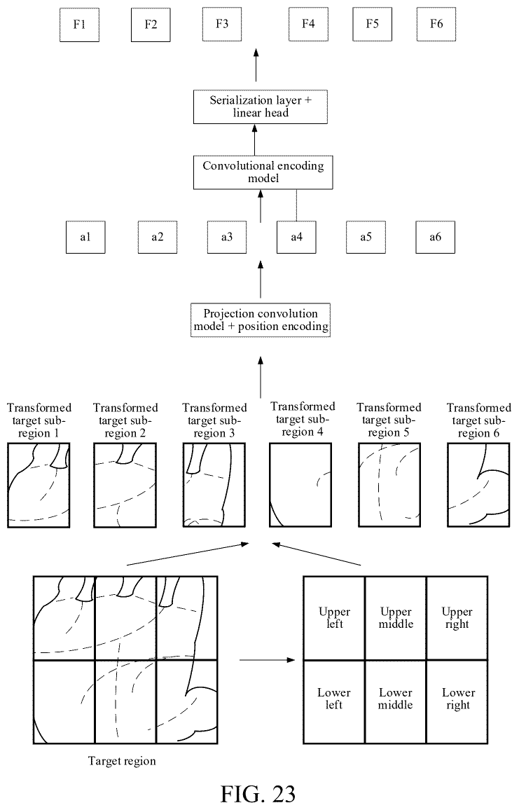

In an example, referring to FIG. 23, the target region is evenly divided to obtain 6 target sub-regions, and sizes of the 6 target sub-regions are standardized to obtain 6 corresponding standard target sub-regions, i.e., a standard target sub-region 1, a standard target sub-region 2, a standard target sub-region 3, a standard target sub-region 4, a standard target sub-region 5, and a standard target sub-region 6. 6 first features may be obtained by inputting the 6 standard target sub-regions into the projection convolution model. Specifically, the projection convolution model may output a first feature 1 according to the inputted standard target sub-region 1, output a first feature 2 according to the inputted standard target sub-region 2, output a first feature 3 according to the inputted standard target sub-region 3, output a first feature 4 according to the inputted standard target sub-region 4, output a first feature 5 according to the inputted standard target sub-region 5, and output a first feature 6 according to the inputted standard target sub-region 6.

In operation 2220, encoding the positions of the plurality of target sub-regions in the target region is to assign one position encoding (position embedding) to each standard target sub-region, so as to perform feature representation on position information of different input channels. This position encoding will be concatenated with the first features of channels as a supplementary feature. For a plurality of standard target sub-regions, positions of the standard target sub-regions in the target region are very important, which may affect the permutation and combination of the standard target sub-regions. That is, the position encoding may not only represent a position of a standard target sub-region in the target region, but also represent a position relationship between the standard target sub-region and another target sub-region.

For example, still referring to FIG. 23, the positions of the standard target sub-regions 1 to 6 in the target region are sequentially upper left, upper middle, upper right, lower left, lower middle, and lower right. If position encodings from 1 to N are assigned to these positions, position encoding 1 of the standard target sub-region 1 is 111, position encoding 2 of the standard target sub-region 2 is 112, position encoding 3 of the standard target sub-region 3 is 113, position encoding 4 of the standard target sub-region 4 is 114, position encoding 5 of the standard target sub-region 5 is 115, and position encoding 6 of the standard target sub-region 6 is 116. In this way, it can be learned based on 6 first features and 6 position encodings that the first feature 1 is at an upper left position of the target region, and adjacent first features include the first feature 2 and the first feature 4. Similarly, a position relationship between other first features may be directly known through position encodings.

In operation 2230, the position encodings of the standard target sub-regions are first merged into the first features of the standard target sub-regions. For example, still referring to FIG. 23, the position encoding 1 is merged into the first feature 1 to obtain a1. Similarly, a2 is obtained according to the position encoding 2 and the first feature 2, a3 is obtained according to the position encoding 3 and the first feature 3, a4 is obtained according to the position encoding 4 and the first feature 4, a5 is obtained according to the position encoding 5 and the first feature 5, and a6 is obtained according to the position encoding 6 and the first feature 6.

Next, after the merged first features of the standard target sub-regions are obtained, the merged first features of the standard target sub-regions are convolved. Still referring to FIG. 23, the merged first features a1 to a6 of the standard target sub-regions may be inputted into the convolutional encoding model, and the convolutional encoding model separately convolves a1 to a6 to obtain 6 convolution results.

Next, the convolution results are serialized, and a plurality of serialization results are concatenated to obtain the second feature of the target region. Serialization refers to converting multi-dimensional inputs into a one-dimensional form. Still referring to FIG. 23, a serialization layer (referred to as a flatten layer) separately serializes the 6 convolution results to obtain serialization results F1 to F6. The serialization results F1 to F6 are sequentially concatenated according to channel dimensions to obtain the second feature of the target region. FIG. 23 further shows a linear head. The linear head mainly aims to make the second feature obtained after the serialization more linear.

An advantage of some embodiments is that the second feature of the target region is jointly determined by the first features and the position encodings of the plurality of target sub-regions. The factors considered are comprehensive so that a problem of unstable palm print recognition caused by the uncertainty of the number and sizes of the target sub-regions may be alleviated, and the palm print recognition accuracy may be further improved.

In some embodiments, operation 2210 includes the following operations: inputting the plurality of standard target sub-regions into a projection convolution model to obtain the first features of the plurality of standard target sub-regions. The projection convolution model includes a convolution layer, a normalization layer, and an activation layer. The convolution layer is configured to perform a convolution operation on pixel matrices of the plurality of standard target sub-regions to obtain convolved matrices of the plurality of standard target sub-regions. The normalization layer is configured to normalize the convolved matrices of the plurality of standard target sub-regions to obtain normalized matrices of the plurality of standard target sub-regions. The activation layer is configured to perform non-linear processing on the normalized matrices of the plurality of standard target sub-regions to obtain the first features of the plurality of standard target sub-regions.

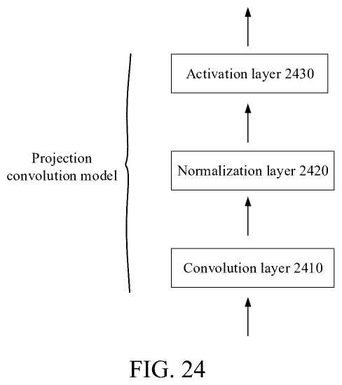

For example, referring to FIG. 24, the projection convolution model shown in FIG. 24 includes a convolution layer 2410, a normalization layer 2420, and an activation layer 2430. The convolution layer 2410 has a weight matrix (convolution kernel). The convolution layer 2410 convolves an inputted pixel matrix of the standard target sub-region through a convolution sum to obtain a convolved matrix, which is used as an input of the normalization layer 2420. The normalization layer 2420 is configured to normalize an inputted convolved matrix, so as to output the convolved matrix to the activation layer 2430. Generally, the input of the model is usually normalized so that the input of the model follows a normal distribution with an average value of u and a variance of h. In this way, the convergence of the model can be accelerated. However, after the input is convolved by the convolution layer 2410, an obtained convolution result may not satisfy the foregoing normal distribution. The function of the normalization layer 2420 is to enable the convolution result to satisfy the normal distribution again, and when the convolution result is inputted into the activation layer 2430, a gradient does not disappear.

The activation layer 2430 is a module including an activation function, and the activation function is, for example, a relu activation function. A convolution operation of the convolution layer 2410 is essentially a linear operation. To take both the simplicity of calculation and the flexibility of the model into consideration, the model adopts a manner of a linear operation of the convolution layer and nonlinear transformation of the activation layer. relu is a piecewise linear function. If an input is positive, the input is directly outputted, otherwise, the output is zero. Advantages of such a design are that the model is easier to train, and better performance can be generally obtained.

In some embodiments, an advantage of the model structure of FIG. 24 is that convolution dimension reduction on the standard target sub-region is realized by providing the convolution layer 2410, thereby improving the model processing precision. In addition, the normalization layer 2420 is provided to reduce a problem that a gradient of the model disappears. The activation layer 2430 is provided so that the model can adapt to complex non-linear decision.

In some embodiments, operation 2230 includes the following operations: inputting the merged first features of the standard target sub-regions into the convolutional encoding model, and convolving, by the convolutional encoding model, the merged first features of the standard target sub-regions, the convolutional encoding model including a first matrix, a second matrix, and a third matrix.

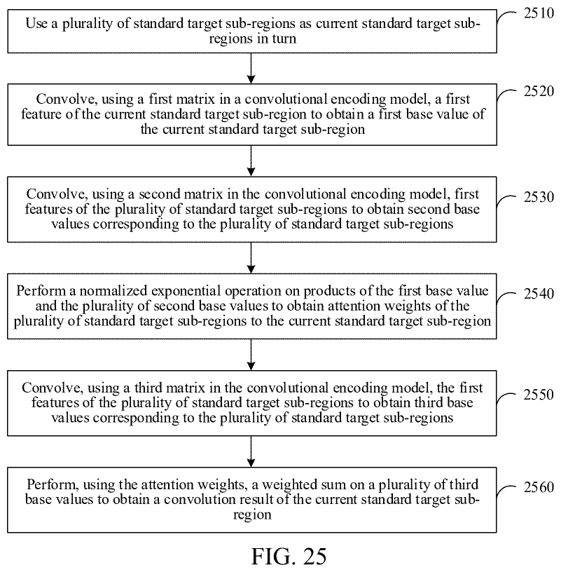

According to some embodiments, referring to FIG. 25, operation 2230 specifically includes the following operations.

Operation 2510: Use the plurality of standard target sub-regions as current standard target sub-regions in turn.

Operation 2520: Convolve, using a first matrix in a convolutional encoding model, a first feature of the current standard target sub-region to obtain a first base value of the current standard target sub-region.

Operation 2530: Convolve, using a second matrix in the convolutional encoding model, the first features of the plurality of standard target sub-regions to obtain second base values corresponding to the plurality of standard target sub-regions.

Operation 2540: Perform a normalized exponential operation on products of the first base value and the plurality of second base values to obtain attention weights of the plurality of standard target sub-regions to the current standard target sub-region.

Operation 2550: Convolve, using a third matrix in the convolutional encoding model, the first features of the plurality of standard target sub-regions to obtain third base values corresponding to the plurality of standard target sub-regions.

Operation 2560: Perform, using the attention weights, a weighted sum on a plurality of third base values to obtain a convolution result of the current standard target sub-region.

Operation 2510 to operation 2560 are described in detail below.

In operation 2510, since inputs of the convolutional encoding model are a plurality of merged first features of the standard target sub-regions, and the convolutional encoding model needs to separately convolve the merged first features of the standard target sub-regions, the plurality of standard target sub-regions are used as current standard target sub-regions in turn. For example, referring to FIG. 23, there are 6 standard target sub-regions in total, i.e., standard target sub-regions 1 to 6, and the standard target sub-regions 1 to 6 are used as current standard target sub-regions in turn.

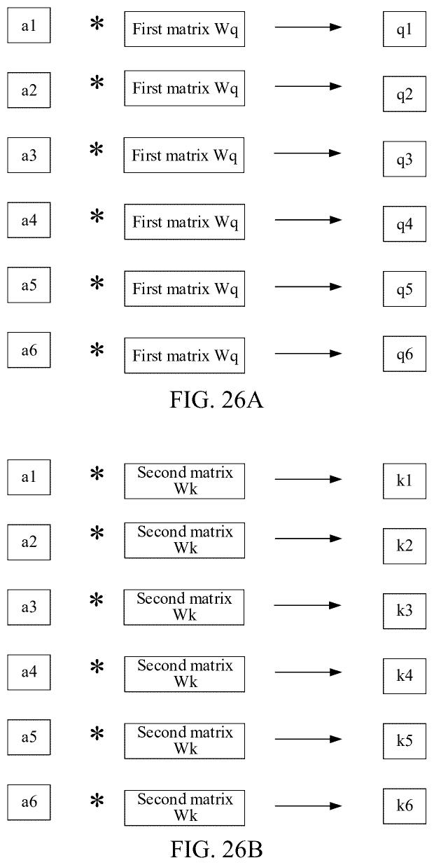

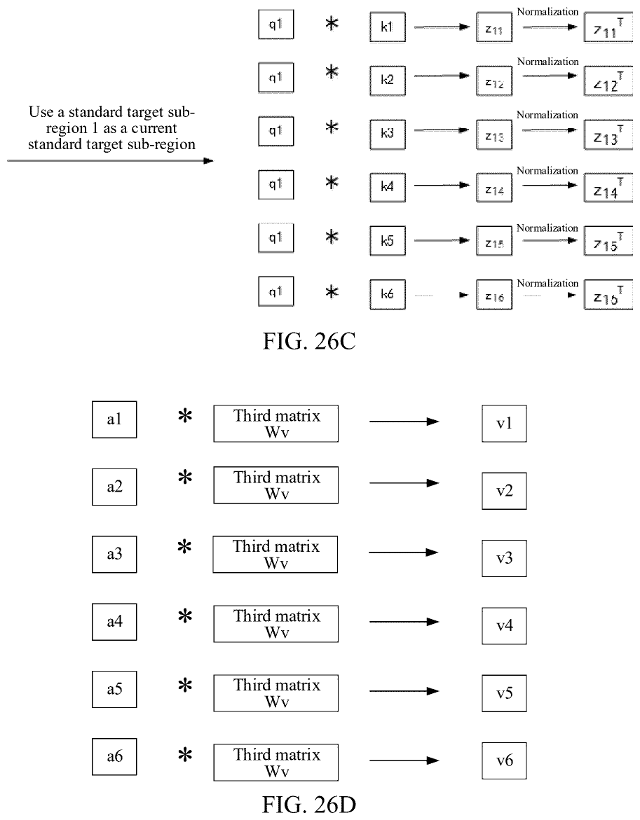

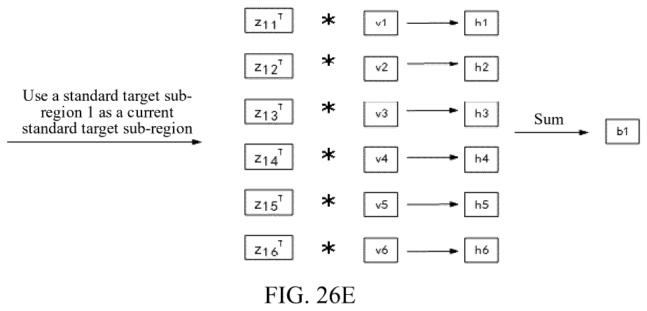

In operation 2520, the first matrix in the convolutional encoding model refers to a numerical table of m1 rows and n1 columns arranged by m1*n1 numbers, and is configured to convolve the first feature of the current standard target sub-region. For example, qi=Wq*ai, i∈(1, n). Referring to FIG. 26A, for a current standard target sub-region 1, a first matrix Wq is multiplied by a first feature a1 of the current standard target sub-region 1 to obtain a first base value q1. Similarly, the first matrix Wq is multiplied by a first feature a2 of a current standard target sub-region 2 to obtain a first base value q2, the first matrix Wq is multiplied by a first feature a3 of a current standard target sub-region 3 to obtain a first base value q3, the first matrix Wq is multiplied by a first feature a4 of a current standard target sub-region 4 to obtain a first base value q4, the first matrix Wq is multiplied by a first feature a5 of a current standard target sub-region 5 to obtain a first base value q5, and the first matrix Wq is multiplied by a first feature a6 of a current standard target sub-region 6 to obtain a first base value q6.

In operation 2530, the second matrix refers to a numerical table of m2 rows and n2 columns arranged by m2*n2 numbers, and is configured to convolve the first features of the plurality of standard target sub-regions. For example, ki=Wk*ai, i∈(1, n). Referring to FIG. 26B, for a standard target sub-region 1, a second matrix Wk is multiplied by a first feature a1 of the standard target sub-region 1 to obtain a second base value k1. Similarly, the second matrix Wk is multiplied by a first feature a2 of a standard target sub-region 2 to obtain a second base value k2, the second matrix Wk is multiplied by a first feature a3 of a standard target sub-region 3 to obtain a second base value k3, the second matrix Wk is multiplied by a first feature a4 of a standard target sub-region 4 to obtain a second base value k4, the second matrix Wk is multiplied by a first feature a5 of a standard target sub-region 5 to obtain a second base value k5, and the second matrix Wk is multiplied by a first feature a6 of a standard target sub-region 6 to obtain a second base value k6.

In operation 2540, the normalized exponential operation is performed on the products of the first base value and the plurality of second base values to obtain the attention weights of the plurality of standard target sub-regions to the current standard target sub-region. For example, qi is separately multiplied by k1, k2, . . . , kn to obtain zᵢ₁, zᵢ₂, . . . , zᵢₙ. Then, a normalized exponential operation is performed to obtain attention weights zᵢ₁^{T}, zᵢ₂^{T}, . . . , zᵢₙ^{T}. Referring to FIG. 26C, in operation 2510, the standard target sub-region 1 is used as the current standard sub-region, and the first base value is q1. Next, the first base value q1 is multiplied by the second base values k1 to k6 to obtain product results z₁₁, z₁₂, z₁₃, z₁₄, z₁₅, and z₁₆. z₁₁, z₁₂, z₁₃, z₁₄, z₁₅, and z₁₆ are inputted into a classifier (for example, softmax) to obtain attention weights z₁₁^{T}, z₁₂^{T}, z₁₃^{T}, z₁₄^{T}, z₁₅^{T}, and z₁₆^{T} with numerical distribution between 0 and 1. Similarly, if the standard target sub-region 2 is used as the current standard sub-region in operation 2510, the first base value is q2, thereby obtaining attention weights z₂₁^{T}, z₂₂^{T}, z₂₃^{T}, z₂₄^{T}, z₂₅^{T}, and z₂₆^{T}. If the standard target sub-region 3 is used as the current standard sub-region in operation 2510, the first base value is q3, thereby obtaining attention weights z₃₁^{T}, z₃₂^{T}, z₂₃^{T}, z₃₄^{T}, z₃₅^{T}, and z₃₆^{T}. If the standard target sub-region 4 is used as the current standard sub-region in operation 2510, the first base value is q4, thereby obtaining attention weights z₄₁^{T}, z₄₂^{T}, z₄₃^{T}, z₄₄^{T}, z₄₅^{T}, and z₄₆^{T}. If the standard target sub-region 5 is used as the current standard sub-region in operation 2510, the first base value is q5, thereby obtaining attention weights z₅₁^{T}, z₅₂^{T}, z₅₃^{T}, z₅₄^{T}, z₅₅^{T}, and z₅₆^{T}. If the standard target sub-region 6 is used as the current standard sub-region in operation 2510, the first base value is q6, thereby obtaining attention weights z₆₁^{T}, z₆₂^{T}, z₆₃^{T}, z₆₄^{T}, z₆₅^{T}, and z₆₆^{T}.

In operation 2550, the third matrix refers to a numerical table of m3 rows and n3 columns arranged by m3*n3 numbers, and is configured to convolve the first features of the plurality of standard target sub-regions. For example, vi=Wv*ai, i∈(1, n). Referring to FIG. 26D, for the standard target sub-region 1, a third matrix Wv is multiplied by the first feature a1 of the standard target sub-region 1 to obtain a third base value v1. Similarly, the third matrix Wv is multiplied by the first feature a2 of the standard target sub-region 2 to obtain a third base value v2, the third matrix Wv is multiplied by the first feature a3 of the standard target sub-region 3 to obtain a third base value v3, the third matrix Wv is multiplied by the first feature a4 of the standard target sub-region 4 to obtain a third base value v4, the third matrix Wv is multiplied by the first feature a5 of the standard target sub-region 5 to obtain a third base value v5, and the third matrix Wv is multiplied by the first feature a6 of the standard target sub-region 6 to obtain a third base value v6.

In operation 2560, a weighted sum is performed on the plurality of third base values using the attention weights obtained in operation 2540 to obtain the convolution result of the current standard target sub-region. For example, attention weights zᵢ₁^{T}, zᵢ₂^{T}, . . . , zᵢₙ^{T} are multiplied by v1, v2, . . . , vn of corresponding positions and then summed to obtain a convolution result bi corresponding to qi. Referring to FIG. 26E, in operation 2510, the standard target sub-region 1 is used as the current standard sub-region, and the attention weights are z₁₁^{T}, z₁₂^{T}, z₁₃^{T}, z₁₄^{T}, z₁₅^{T}, and z₁₆^{T}. Then, z₁₁^{T}, z₁₂^{T}, z₁₃^{T}, z₁₄^{T}, z₁₅^{T}, and z₁₆^{T} are multiplied by v1 to v6 of corresponding positions to obtain product results h1, h2, h3, h4, h5, and h6. h1, h2, h3, h4, h5, and h6 are summed to obtain b1. Similarly, if the standard target sub-region 2 is used as the current standard sub-region, a weighted sum is performed on z₂₁^{T}, z₂₂^{T}, z₂₃^{T}, z₂₄^{T}, z₂₅^{T}, and z₂₆^{T} and v1 to v6 of corresponding positions to obtain b2. If the standard target sub-region 3 is used as the current standard sub-region, a weighted sum is performed on z₃₁^{T}, z₃₂^{T}, z₂₃^{T}, z₃₄^{T}, z₃₅^{T}, and z₃₆^{T} and v1 to v6 of corresponding positions to obtain b3. If the standard target sub-region 4 is used as the current standard sub-region, a weighted sum is performed on z₄₁^{T}, z₄₂^{T}, z₄₃^{T}, z₄₄^{T}, z₄₅^{T}, and z₄₆^{T} and v1 to v6 of corresponding positions to obtain b4. If the standard target sub-region 5 is used as the current standard sub-region, a weighted sum is performed on z₅₁^{T}, z₅₂^{T}, z₅₃^{T}, z₅₄^{T}, z₅₅^{T}, and z₅₆^{T} and v1 to v6 of corresponding positions to obtain b5. If the standard target sub-region 6 is used as the current standard sub-region, a weighted sum is performed on z₆₁^{T}, z₆₂^{T}, z₆₃^{T}, z₆₄^{T}, z₆₅^{T}, and z₆₆^{T} and v1 to v6 of corresponding positions to obtain b6.

After operation 2510 to operation 2560, the convolution results b1 to b6 outputted by a convolutional encoder may be obtained, and then the convolution results b1 to b6 are serialized to obtain 6 serialization results, i.e., F1 to F6 shown in FIG. 23. Further, the serialization results are concatenated to obtain the second feature of the target region.

An advantage of some embodiments is that, based on the first matrix, the second matrix, and the third matrix, an attention weight from another standard target sub-region may be applied to each standard target sub-region, reflecting the connection and effect among the plurality of target sub-regions, greatly improving the extraction accuracy of the second feature, thereby improving the palm print recognition accuracy.

In the foregoing embodiment, the convolutional encoding model includes the first matrix, the second matrix, and the third matrix. To further improve the feature extraction efficiency and accuracy, a convolutional encoding model based on a converter structure in another embodiment is described below.

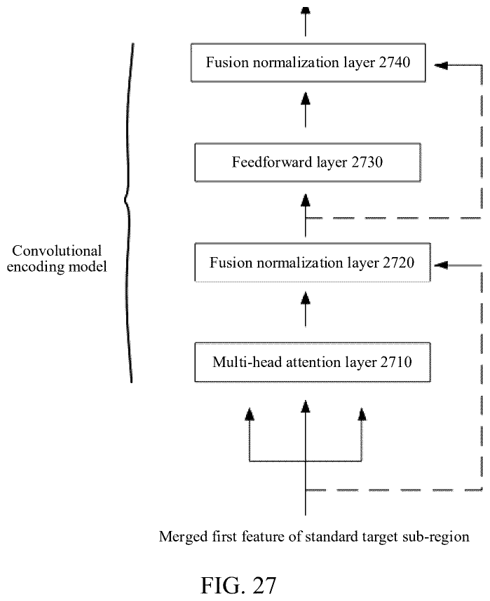

Referring to FIG. 27, the convolutional encoding model includes a multi-head attention layer 2710, a fusion normalization layer 2720, a feedforward layer 2730, and a fusion normalization layer 2740.

The multi-head attention layer 2710 includes the first matrix, the second matrix, and the third matrix. Therefore, a specific processing process in which the multi-head attention layer 2710 convolves the merged first features of the standard target sub-regions may refer to the foregoing operation 2510 to operation 2560. Compared with the convolutional encoding model in the embodiments of operation 2510 to operation 2560, the convolutional encoding model shown in FIG. 27 further includes the fusion normalization layer 2720, the feedforward layer 2730, and the fusion normalization layer 2740. Only one multi-head attention layer 2710 is shown in FIG. 27, but two or more cascaded multi-head attention layers may be set according to requirements.

The fusion normalization layer 2720 is a module that performs fusion (Add) and normalization (Norm) on the features. As shown in FIG. 27, the fusion normalization layer 2720 fuses the output of the multi-head attention layer and the merged first features of the standard target sub-regions, normalizes the fused feature, and then outputs the fused feature to the feedforward layer 2730.

The feedforward layer 2730, referred to as a feed-forward layer, refers to a unidirectional multilayer network structure. Information starts from an input layer, is transferred layer by layer to one direction, and ends at an output layer. Feedforward refers to that an input/output direction is a forward direction, and the weight is not adjusted in this process. As shown in FIG. 27, the feedforward layer 2730 transfers an output of the fusion normalization layer 2720 to the fusion normalization layer 2740.

The fusion normalization layer 2740 refers to a module that performs fusion (Add) and normalization (Norm) on the features. As shown in FIG. 27, the fusion normalization layer 2740 fuses an output of the feedforward layer 2730 and an output of the fusion normalization layer 2720, normalizes the fused feature, and then uses the normalized feature as an output of the convolutional encoding model.

An advantage of some embodiments is that in addition to using the multi-head attention layer to reflect the connection and effect among the plurality of target sub-regions, feature extraction of a residual connection is realized using the fusion normalization layer and the feedforward layer to better extract and integrate the first features of the palm, further improving the extraction accuracy of the second feature, thereby improving the palm print recognition accuracy.

In operation 350, the palm print recognition result corresponding to the target palm image is determined based on the second feature of the target region.

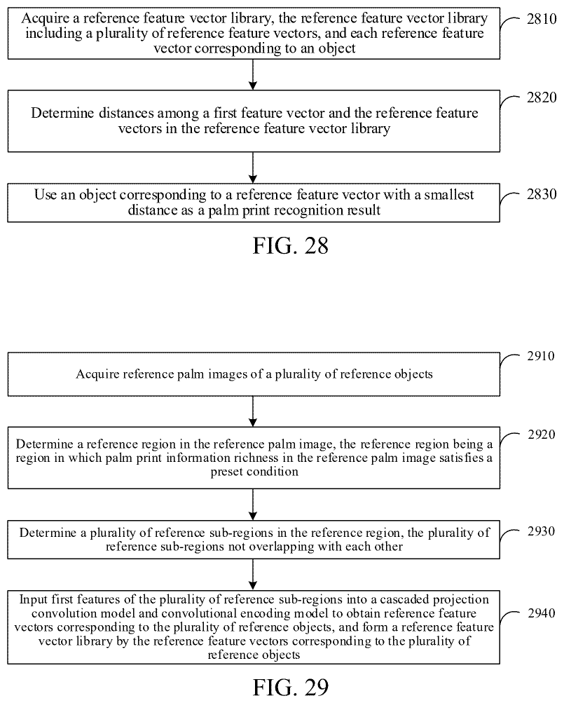

Referring to FIG. 28, in some embodiments, the second feature of the target region is a first feature vector, and operation 350 includes the following operations.

Operation 2810: Acquire a reference feature vector library, the reference feature vector library including a plurality of reference feature vectors, and each reference feature vector corresponding to an object.

Operation 2820: Determine distances among the first feature vector and the reference feature vectors in the reference feature vector library.

Operation 2830: Use an object corresponding to a reference feature vector with a smallest distance as the palm print recognition result.

Operation 2810 to operation 2830 are described in detail below.

In operation 2810, the reference feature vector library is a database configured for storing the reference feature vectors. The reference feature vector and the first feature vector are similar and configured for representing the second feature extracted from the palm image. A difference between the two is that, the reference feature vector is stored in the reference feature vector library in advance and is in a one-to-one correspondence with the object, while the first feature vector is extracted from the target palm image, and an object corresponding to the first feature vector is temporarily unknown.

Next, in operation 2820, to determine the object corresponding to the first feature vector, the distances among the first feature vector and the reference feature vectors in the reference feature vector library need to be determined. A smaller distance indicates higher similarity between the first feature vector and the reference feature vector. Therefore, the reference feature vector with the smallest distance may be configured for representing the first feature vector. For example, the distance may be a Euclidean distance or cosine similarity between the first feature vector and the reference feature vector.

In some embodiments, a formula for calculating the cosine similarity is as follows:

$$s i m ( v e c t o {r}_{r e g} , vecto {r}_{r e c} ) = \frac{\vec{{vector}_{r e g}} \times \vec{{vector}_{r e c}}}{‖ {vector}_{r e g} ‖ \times ‖ {vector}_{r e c} ‖} , \qquad Formula 4$$

where sim(vector_{reg},vector_{rec}) is the cosine similarity, vector_{reg} is the reference feature vector, and vector_{rec} is the first feature vector.

Next, in operation 2830, the object corresponding to the reference feature vector with the smallest distance is used as the palm print recognition result. For example, sorting is performed according to the distances among the first feature vector and the reference feature vectors in ascending order of the distances, an object identifier of a reference feature vector corresponding to the smallest distance is determined, and the object identifier is used as the palm print recognition result.

An advantage of some embodiments is that the object corresponding to the first feature vector may be quickly determined based on the distances among the first feature vector and the reference feature vectors, thereby improving the accuracy and efficiency of palm print recognition.

Referring to FIG. 29, in some embodiments, operation 2810 includes the following operations.

Operation 2910: Acquire reference palm images of a plurality of reference objects.

Operation 2920: Determine a reference region in the reference palm image, the reference region being a region in which the palm print information richness in the reference palm image satisfies the preset condition.

Operation 2930: Determine a plurality of reference sub-regions in the reference region, the plurality of reference sub-regions not overlapping with each other.

Operation 2940: Input first features of the plurality of reference sub-regions into a cascaded projection convolution model and convolutional encoding model to obtain the reference feature vectors corresponding to the plurality of reference objects, and forming the reference feature vector library by the reference feature vectors corresponding to the plurality of reference objects.

Operation 2910 to operation 2940 are described in detail below.

Operation 2910 to operation 2930 are similar to operation 310 to operation 330 above. Related explanations and functions may refer to the foregoing descriptions. To reduce space, details are not described herein again.

The projection convolution model in operation 2940 is the same as the projection convolution model in operation 2210 above, and the convolutional encoding model in operation 2940 is the same as the convolutional encoding model in operation 2230 above. Related explanations and functions may refer to the foregoing descriptions. To reduce space, details are not described herein again.

In operation 2940, the first features of the plurality of reference sub-regions obtained from a reference palm image may represent the reference palm image so that the reference feature vectors outputted through the projection convolution model and the convolutional encoding model may represent the reference object. The reference feature vector library including a plurality of reference feature vectors is equivalent to a registered feature database, and the first feature vector obtained from the target palm image is used as a to-be-recognized feature to obtain an object corresponding to the to-be-recognized feature based on the registered feature database.

An advantage of some embodiments is that the reference feature vectors of the plurality of reference objects are stored in the reference feature vector library in advance so that during palm print recognition, the object corresponding to the reference feature vector with the smallest distance can be quickly obtained from the reference feature vector library, thereby greatly improving the efficiency and accuracy of palm print recognition. In addition, determining, based on the first features of the plurality of reference sub-regions included in the reference region in the reference palm image, the reference feature vector representing the reference object corresponding to the reference palm image may ensure the accuracy of the determined reference feature vector. Moreover, the determined reference feature vector is as distinctly different as possible from other reference feature vectors.

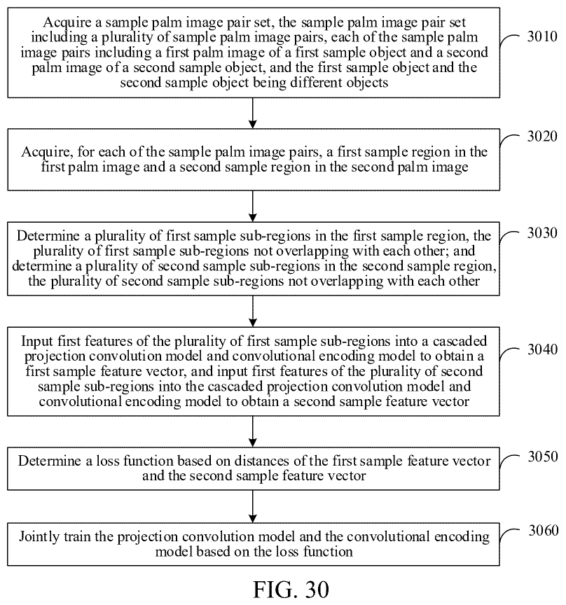

Referring to FIG. 30, in some embodiments, the projection convolution model and the convolutional encoding model are jointly trained in the following manners.

Operation 3010: Acquire a sample palm image pair set, the sample palm image pair set including a plurality of sample palm image pairs, each of the sample palm image pairs including a first palm image of a first sample object and a second palm image of a second sample object, and the first sample object and the second sample object being different objects.

Operation 3020: Determine, for each of the sample palm image pairs, a first sample region in the first palm image and a second sample region in the second palm image.

Operation 3030: Determine a plurality of first sample sub-regions in the first sample region, the plurality of first sample sub-regions not overlapping with each other; and determine a plurality of second sample sub-regions in the second sample region, the plurality of second sample sub-regions not overlapping with each other.

Operation 3040: Input first features of the plurality of first sample sub-regions into the cascaded projection convolution model and convolutional encoding model to obtain a first sample feature vector, and input first features of the plurality of second sample sub-regions into the cascaded projection convolution model and convolutional encoding model to obtain a second sample feature vector.

Operation 3050: Determine a loss function based on distances of the first sample feature vector and the second sample feature vector.

Operation 3060: Jointly train the projection convolution model and the convolutional encoding model based on the loss function.

Operation 3010 to operation 3060 are described in detail below.

The sample palm image pair set in operation 3010 includes a plurality of sample palm image pairs. Each sample palm image pair includes the first palm image of the first sample object and the second palm image of the second sample object. A larger number of sample palm image pairs indicates a better training effect. The first sample object refers to an object used as a sample, and the second sample object refers to another object used as a sample. For example, the first sample object and the second sample object may be identical twins, and the first palm image and the second palm image refer to left-hand palm or right-hand palm images of the identical twins. The first palm image and the second palm image herein are similar to the target palm image in operation 310. However, the first palm image and the second palm image are configured for model training, and the target palm image is configured for actual use of the model.

A label corresponding to a sample is usually needed during model training. However, since the first sample object and the second sample object in the sample palm image pair set are different objects, which is equivalent to that a label of each sample palm image pair is already provided, no additional manual marking work is needed in some embodiments, thereby greatly saving labor costs.

Next, operation 3020 to operation 3040 are similar to operation 2920 to operation 2940 above. Related explanations and functions may refer to the foregoing descriptions. To reduce space, details are not described herein again. However, operation 3020 to operation 3040 are a model training process, and operation 2920 to operation 2950 are an actual use process of the model.

Next, in operation 3050, the loss function is determined based on the distances of the first sample feature vector and the second sample feature vector. For example, the distance may be a Euclidean distance or cosine similarity between the first sample feature vector and the second sample feature vector. After the distance is obtained, the loss function is determined based on the distance. The loss function is a function configured for measuring a determining loss of the cascaded projection convolution model and convolutional encoding model, and can reflect the training effect of the projection convolution model and the convolutional encoding model. A smaller loss function indicates better training of the projection convolution model and the convolutional encoding model.

In some embodiments, operation 3060 includes the following operations:
determining the distances for the sample palm image pairs;
averaging the distances of the sample palm image pairs in the sample palm image pair set to obtain an average distance; and
determining the loss function based on the average distance.

In some embodiments, the distance of each sample palm image pair may refer to the formula 4 above so that a loss function may be constructed as follows:

$$L = 1 - cosine\_mean , \qquad Formula 5$$

where L is the loss function, and cosine_mean is the average distance, i.e., average cosine similarity. For example, it is assumed that there are only 3 sample palm image pairs in the sample palm image pair set. The cosine similarity of a first sample palm image pair is 0.8, the cosine similarity of a second sample palm image pair is 0.9, and the cosine similarity of a third sample palm image pair is 0.7. In this way, the average cosine similarity cosine_mean is (0.8+0.9+0.7)/3=0.8. Then, the loss function L is 1-0.8=0.2.

In operation 3060, the projection convolution model and the convolutional encoding model are jointly trained based on the loss function obtained in the foregoing operation. For example, the projection convolution model and the convolutional encoding model are jointly trained based on the loss function, that is, parameters of the projection convolution model and the convolutional encoding model are jointly adjusted. Specifically, a second threshold may be preset. When a ratio of sample palm image pairs whose loss function is less than the second threshold in the sample palm image pair set is greater than a third threshold, the training process ends. Otherwise, the parameters of the projection convolution model and the convolutional encoding model are jointly adjusted until the ratio of the sample palm image pairs whose loss function is less than the second threshold in the sample palm image pair set is greater than the third threshold.

An advantage of some embodiments is that by jointly training the projection convolution model and the convolutional encoding model, the parameters in the projection convolution model and the parameters in the convolutional encoding model may affect each other, thereby improving the recognition accuracy of the palm image by the trained model.

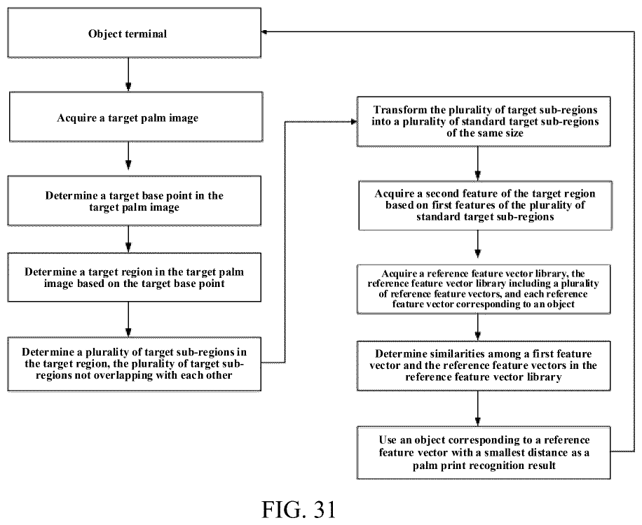

The palm print recognition method according to some embodiments are described in detail below with reference to FIG. 31.

Some embodiments include the following implementation details:
(1) starting an object terminal;
(2) acquiring a target palm image;
(3) determining a target base point in the target palm image;
(4) determining a target region in the target palm image based on the target base point;
(5) determining a plurality of target sub-regions in the target region, the plurality of target sub-regions not overlapping with each other;
(6) transforming the plurality of target sub-regions into a plurality of standard target sub-regions of the same size;
(7) acquiring a second feature of the target region based on first features of the plurality of standard target sub-regions;
(8) acquiring a reference feature vector library, the reference feature vector library including a plurality of reference feature vectors, and each reference feature vector corresponding to an object;
(9) determining similarities among a first feature vector and the reference feature vectors in the reference feature vector library;
(10) using an object corresponding to a reference feature vector with the largest similarity as a palm print recognition result; and
(11) returning to the object terminal, and ending.

Advantages of some embodiments include, but are not limited to: the second feature extracted from the target palm image covers a plurality of highly discriminative positions in the palm, thereby improving the accuracy of palm print recognition.

Although the various operations in the foregoing flowcharts are shown sequentially as indicated by the arrows, these operations are not necessarily performed sequentially in the order indicated by the arrows. Unless otherwise explicitly specified in the embodiments, execution of the operations is not strictly limited, and the operations may be performed in other orders. Moreover, at least some of the operations in the flowcharts may include a plurality of operations or a plurality of stages. The operations or stages are not necessarily performed at the same time but may be performed at different time. Execution of the operations or stages is not necessarily sequentially performed, but may be performed in turn or with other operations or at least some of operations or stages of other operations.

In some embodiments, when related processing needs to be performed according to data related to a target object characteristic, such as attribute information or an attribute information set of the target object, permission or consent of the target object is first obtained, and acquisition, usage, processing, and the like of the data comply with related laws, regulations, and standards. In addition, when the attribute information of the target object needs to be obtained in some embodiments, individual permission or individual consent of the target object is obtained through a pop-up window or jumping to a confirmation page. After the individual permission or the individual consent of the target object is explicitly obtained, necessary data related to the target object for enabling some embodiments to operate normally is obtained.

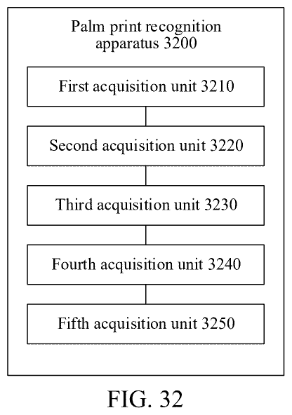

FIG. 32 is a schematic structural diagram of a palm print recognition apparatus 3200 according to some embodiments. The palm print recognition apparatus 3200 include:
a first acquisition unit 3210 configured to acquire a target palm image;
a second acquisition unit 3220 configured to determine a target region in the target palm image, the target region being a region in which palm print information richness in the target palm image satisfies a preset condition;
a third acquisition unit 3230 configured to determine a plurality of target sub-regions in the target region, the plurality of target sub-regions not overlapping with each other;
a fourth acquisition unit 3240 configured to determine a second feature of the target region based on first features of the plurality of target sub-regions; and
a fifth acquisition unit 3250 configured to determine a palm print recognition result corresponding to the target palm image based on the second feature of the target region.

In some embodiments, the second acquisition unit 3220 is configured to:
determine a target base point in the target palm image; and
determine the target region in the target palm image based on the target base point.

In some embodiments, the target base point includes a first target base point, a second target base point, and a third target base point, and the second target base point is located between the first target base point and the third target base point.

The second acquisition unit 3220 is configured to:
establish a rectangular coordinate system based on a connecting line between the first target base point and the third target base point, and a straight line that is perpendicular to the connecting line and passes through the second target base point:
determine a target region center on the rectangular coordinate system; and
determine the target region based on the target region center.

In some embodiments, the second acquisition unit 3220 is specifically configured to:
determine an origin of the rectangular coordinate system;
determine a first distance between the first target base point and the third target base point:
determine, based on the first distance, a second distance between the target region center and the origin; and
determine the target region center on the rectangular coordinate system according to the origin and the second distance, where the target region center is located on a target axis to which the second target base point belongs, and the target region center and the second target base point are distributed on two sides of the origin.

In some embodiments, the target region is a square, and based on the target region center, the second acquisition unit 3220 is further specifically configured to:
determine a third distance based on the first distance;
determine a point on the target axis at the third distance from the target region center as a boundary anchor point; and
determine the target region based on the target region center and the boundary anchor point.

In some embodiments, the target region is a square, and the second acquisition unit 3220 is specifically configured to:
determine a side length of the square based on the first distance; and
determine the target region based on the target region center and the side length of the square.

In some embodiments, the first target base point is an intersection point of a finger gap between index and middle fingers and the palm, the second target base point is an intersection point of a finger gap between middle and ring fingers and the palm, and the third target base point is an intersection point of a finger gap between ring and little fingers and the palm.

In some embodiments, the plurality of target sub-regions are a first number of target sub-regions.

The third acquisition unit 3230 is configured to:
divide the target region into the first number of partitions; and
determine a target sub-region in each of the partitions, where a boundary of the target sub-region is located within a boundary of the partition.

In some embodiments, the target sub-region is a rectangle, and the plurality of target sub-regions are a second number of target sub-regions.

The third acquisition unit 3230 is further specifically configured to:
set an acquired target sub-region set, the acquired target sub-region set being initially an empty set;
perform a first process, the first process including: selecting a target sub-region basis point from a range that is in the target region and not covered by target sub-regions in the acquired target sub-region set; acquiring a first length and a second length; generating, based on the target sub-region basis point, the target sub-region using the first length as a length of the target sub-region and the second length as a width of the target sub-region; adding, if a generated target sub-region does not overlap with any target sub-region in the acquired target sub-region set, the generated target sub-region to the acquired target sub-region set; otherwise, deleting the generated target sub-region; and repeatedly performing the first process until the number of target sub-regions in the acquired target sub-region set reaches the second number.

In some embodiments, the third acquisition unit 3230 is further specifically configured to:
acquire a side length of the target region;
determine a first threshold based on the side length and a first ratio; and
randomly generate a first length and a second length so that the first length and the second length are both less than the first threshold.

In some embodiments, the fourth acquisition unit 3240 is specifically configured to:
transform the plurality of target sub-regions into a plurality of standard target sub-regions of the same size; and
determine the second feature of the target region based on first features of the plurality of standard target sub-regions.

In some embodiments, the fourth acquisition unit 3240 is further specifically configured to:
perform projection convolution on the plurality of standard target sub-regions to obtain the first features of the plurality of standard target sub-regions;
encode positions of the plurality of target sub-regions in the target region to obtain position encodings of the plurality of standard target sub-regions; and
merge the position encodings of the standard target sub-regions into the first features of the standard target sub-regions, convolve merged first features of the standard target sub-regions, serialize convolution results, and concatenate a plurality of serialization results to obtain the second feature of the target region.

In some embodiments, the fourth acquisition unit 3240 is further specifically configured to:
input the plurality of standard target sub-regions into a projection convolution model to obtain the first features of the plurality of standard target sub-regions, where the projection convolution model includes a convolution layer, a normalization layer, and an activation layer;
the convolution layer is configured to perform a convolution operation on pixel matrices of the plurality of standard target sub-regions to obtain convolved matrices of the plurality of standard target sub-regions;
the normalization layer is configured to normalize the convolved matrices of the plurality of standard target sub-regions to obtain normalized matrices of the plurality of standard target sub-regions; and
the activation layer is configured to perform non-linear processing on the normalized matrices of the plurality of standard target sub-regions to obtain the first features of the plurality of standard target sub-regions.

In some embodiments, the fourth acquisition unit 3240 is further specifically configured to:
use the plurality of standard target sub-regions as current standard target sub-regions in turn;
convolve, using a first matrix in a convolutional encoding model, a first feature of the current standard target sub-region to obtain a first base value of the current standard target sub-region;
convolve, using a second matrix in the convolutional encoding model, the first features of the plurality of standard target sub-regions to obtain second base values corresponding to the plurality of standard target sub-regions:
perform a normalized exponential operation on products of the first base value and the plurality of second base values to obtain attention weights of the plurality of standard target sub-regions to the current standard target sub-region:
convolve, using a third matrix in the convolutional encoding model, the first features of the plurality of standard target sub-regions to obtain third base values corresponding to the plurality of standard target sub-regions; and
perform, using the attention weights, a weighted sum on a plurality of third base values to obtain a convolution result of the current standard target sub-region.

In some embodiments, the second feature of the target region is a first feature vector, and the fifth acquisition unit 3250 is configured to:
acquire a reference feature vector library, the reference feature vector library including a plurality of reference feature vectors, and each reference feature vector corresponding to an object;
determine distances among the first feature vector and the reference feature vectors in the reference feature vector library; and
use an object corresponding to a reference feature vector with a smallest distance as the palm print recognition result.

In some embodiments, the fifth acquisition unit 3250 is further configured to:
acquire reference palm images of a plurality of reference objects;
determine a reference region in the reference palm image, the reference region being a region in which the palm print information richness in the reference palm image satisfies the preset condition;
determine a plurality of reference sub-regions in the reference region, the plurality of reference sub-regions not overlapping with each other; and
input first features of the plurality of reference sub-regions into a cascaded projection convolution model and convolutional encoding model to obtain the reference feature vectors corresponding to the plurality of reference objects, and forming the reference feature vector library by the reference feature vectors corresponding to the plurality of reference objects.

In some embodiments, the fifth acquisition unit 3250 is further specifically configured to:
acquire a sample palm image pair set, the sample palm image pair set including a plurality of sample palm image pairs, each of the sample palm image pairs including a first palm image of a first sample object and a second palm image of a second sample object, and the first sample object and the second sample object being different objects;
determine, for each of the sample palm image pairs, a first sample region in the first palm image and a second sample region in the second palm image;
determine a plurality of first sample sub-regions in the first sample region, the plurality of first sample sub-regions not overlapping with each other; and determine a plurality of second sample sub-regions in the second sample region, the plurality of second sample sub-regions not overlapping with each other;
input first features of the plurality of first sample sub-regions into the cascaded projection convolution model and convolutional encoding model to obtain a first sample feature vector, and input first features of the plurality of second sample sub-regions into the cascaded projection convolution model and convolutional encoding model to obtain a second sample feature vector;
determine a loss function based on distances of the first sample feature vector and the second sample feature vector; and
jointly train the projection convolution model and the convolutional encoding model based on the loss function.

In some embodiments, the fifth acquisition unit 3250 is further specifically configured to:
determine the distances for the sample palm image pairs;
average the distances of the sample palm image pairs in the sample palm image pair set to obtain an average distance; and
determine the loss function based on the average distance.

According to some embodiments, each unit in the apparatus may exist respectively or be combined into one or more units. Certain (or some) unit in the units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each module and unit are executable by a processor to thereby cause the processor to perform the respective operations of the corresponding unit.

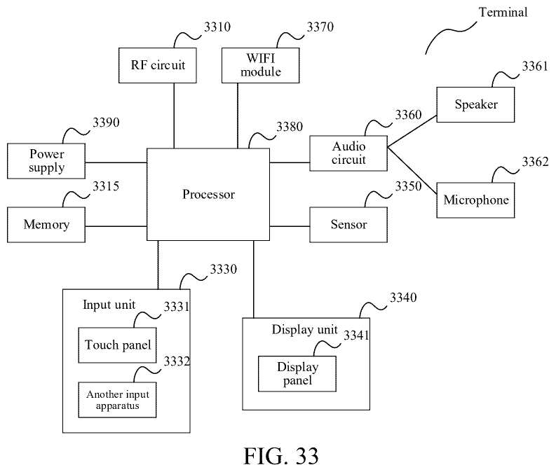

FIG. 33 is a structural block diagram of a part of a terminal that implements the palm print recognition method in some embodiments. The terminal includes: components such as a radio frequency (RF) circuit 3310, a memory 3315, an input unit 3330, a display unit 3340, a sensor 3350, an audio circuit 3360, a wireless fidelity (Wi-Fi) module 3370, a processor 3380, and a power supply 3390. A person skilled in the art may understand that a structure of the terminal shown in FIG. 33 does not constitute a limitation to a mobile phone or a computer, and the mobile phone or the computer may include more components or fewer components than those shown in the figure, or some components may be combined, or a different component arrangement may be used.

The RF circuit 3310 may be configured to receive and transmit signals during an information receiving and transmitting process or a call process. Specifically, the RF circuit 1010 receives downlink information from a base station, and then delivers the downlink information to the processor 3380 for processing. In addition, the designed uplink data is transmitted to the base station.

The memory 3315 may be configured to store a software program and a module, and the processor 3380 executes various function applications of the object terminal and performs data processing by running the software program and the module stored in the memory 3315.

The input unit 3330 may be configured to receive inputted digit or character information and generate a key signal input related to settings and function control of the object terminal. Specifically, the input unit 3330 may include a touch panel 3331 and another input apparatus 3332.

The display unit 3340 may be configured to display inputted information or provided information, and various menus of the object terminal. The display unit 3340 may include a display panel 3341.

The audio circuit 3360, a speaker 3361, and a microphone 3362 may provide audio interfaces.

In some embodiments, the processor 3380 included in the terminal may perform the palm print recognition method in the foregoing embodiments.

The terminal in some embodiments includes, but is not limited to, a mobile phone, a computer, a smart voice interaction device, a smart home appliance, an in-vehicle terminal, an aircraft, and the like. Some embodiments may be applied to various scenes, including but not limited to a mobile payment scene, an identity verification scene, an attendance system scene, an access control system scene, and the like.

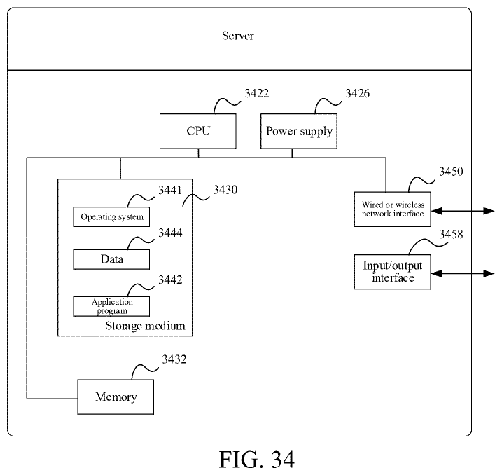

FIG. 34 is a structural block diagram of a part of a server that implements the palm print recognition method in some embodiments. The server may vary greatly due to different configurations or performance, and may include one or more central processing units (CPUs) 3422 (for example, one or more processors) and a memory 3432, and one or more storage media 3430 (for example, one or more mass storage apparatuses) that store the application program 3442 or data 3444. The memory 3432 and the storage medium 3430 may be transient storage or persistent storage. A program stored in the storage medium 3430 may include one or more modules (not marked in the figure), and each module may include a series of instruction operations on the server. Further, the CPU 3422 may be configured to communicate with the storage medium 3430, and perform, on the server, the series of instruction operations in the storage medium 3430.

The server may further include one or more power supplies 3426, one or more wired or wireless network interfaces 3450, one or more input/output interfaces 3458, and/or one or more operating systems 3441 such as Windows Server™, Mac OS X™, Unix™, Linux™, and FreeBSD™.

The CPU 3422 in the server may be configured to perform the palm print recognition method in some embodiments.

Some embodiments further provide a computer-readable storage medium. The computer-readable storage medium is configured to store program code. The program code is configured for performing the palm print recognition method according to the foregoing embodiments.

Some embodiments further provide a computer program product, and the computer program product includes a computer program. A processor of a computer device reads and executes the computer program to cause the computer device to perform the foregoing palm print recognition method.

The terms “first”, “second”, “third”, “fourth”, and the like (if any) as used herein and the foregoing accompanying drawings are used for distinguishing similar objects and are not necessarily used for describing a particular order or sequence. Data used in this way is exchangeable in a proper case so that some embodiments described herein can be implemented in an order different from the order shown or described herein. Moreover, the terms “include”, “contain” and any other variants mean to cover the non-exclusive inclusion, for example, a process, method, system, product, or apparatus that includes a list of operations or units is not necessarily limited to those expressly listed operations or units, but may include other operations or units not expressly listed or inherent to such a process, method, product, or apparatus.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A palm print recognition method, performed by an electronic device, comprising:
acquiring a target palm image;
determining a target region in the target palm image, the target region being a region in which palm print information richness in the target palm image satisfies a preset condition;
determining a plurality of target sub-regions in the target region, the plurality of target sub-regions not overlapping with each other;
determining a second feature of the target region based on first features of the plurality of target sub-regions; and
determining a palm print recognition result corresponding to the target palm image based on the second feature of the target region.

2. The palm print recognition method according to claim 1, wherein determining the target region in the target palm image comprises:
determining a target base point in the target palm image; and
determining the target region in the target palm image based on the target base point.

3. The palm print recognition method according to claim 2, wherein the target base point comprises a first target base point, a third target base point, and a second target base point located between the first target base point and the third target base point; and
wherein determining the target region in the target palm image based on the target base point comprises:
establishing a rectangular coordinate system based on a connecting line between the first target base point and the third target base point, and a straight line that is perpendicular to the connecting line and passes through the second target base point;
determining a target region center on the rectangular coordinate system; and
determining the target region based on the target region center.

4. The palm print recognition method according to claim 3, wherein determining the target region center on the rectangular coordinate system comprises:
determining an origin of the rectangular coordinate system;
determining a first distance between the first target base point and the third target base point;
determining, based on the first distance, a second distance between the target region center and the origin; and
determining the target region center on the rectangular coordinate system according to the origin and the second distance, wherein the target region center is located on a target axis to which the second target base point belongs, and the target region center and the second target base point are distributed on two sides of the origin.

5. The palm print recognition method according to claim 4, wherein the target region is a square; and
wherein determining the target region based on the target region center comprises:
determining a third distance based on the first distance;
determining a point on the target axis at the third distance from the target region center as a boundary anchor point; and
determining the target region based on the target region center and the boundary anchor point.

6. The palm print recognition method according to claim 4, wherein the target region is a square; and
wherein determining the target region based on the target region center comprises:
determining a side length of the square based on the first distance; and
determining the target region based on the target region center and the side length of the square.

7. The palm print recognition method according to claim 3, wherein the first target base point is an intersection point of a finger gap between index and middle fingers and the palm, the second target base point is an intersection point of a finger gap between middle and ring fingers and the palm, and the third target base point is an intersection point of a finger gap between ring and little fingers and the palm.

8. The palm print recognition method according to claim 1, wherein the plurality of target sub-regions are a first number of target sub-regions; and
wherein determining the plurality of target sub-regions in the target region comprises:
dividing the target region into the first number of partitions; and
determining a target sub-region in each of the first number of partitions, wherein a boundary of each target sub-region is located within a boundary of a corresponding partition.

9. The palm print recognition method according to claim 1, wherein determining the second feature of the target region based on first features of the plurality of target sub-regions comprises:
transforming the plurality of target sub-regions into a plurality of standard target sub-regions of the same size; and
determining the second feature of the target region based on first features of the plurality of standard target sub-regions.

10. The palm print recognition method according to claim 9, wherein determining the second feature of the target region based on the first features of the plurality of standard target sub-regions comprises:
performing projection convolution on the plurality of standard target sub-regions to obtain the first features of the plurality of standard target sub-regions;
encoding positions of the plurality of target sub-regions in the target region to obtain position encodings of the plurality of standard target sub-regions; and
merging the position encodings of the standard target sub-regions into the first features of the standard target sub-regions, convolving merged first features of the standard target sub-regions, serializing convolution results, and concatenating a plurality of serialization results to obtain the second feature of the target region.

11. The palm print recognition method according to claim 10, wherein performing projection convolution on the plurality of standard target sub-regions to obtain the first features of the plurality of standard target sub-regions comprises:
inputting the plurality of standard target sub-regions into a projection convolution model to obtain the first features of the plurality of standard target sub-regions, wherein the projection convolution model comprises a convolution layer, a normalization layer, and an activation layer;
wherein the convolution layer is configured to perform a convolution operation on pixel matrices of the plurality of standard target sub-regions to obtain convolved matrices of the plurality of standard target sub-regions;
wherein the normalization layer is configured to normalize the convolved matrices of the plurality of standard target sub-regions to obtain normalized matrices of the plurality of standard target sub-regions; and
wherein the activation layer is configured to perform non-linear processing on the normalized matrices of the plurality of standard target sub-regions to obtain the first features of the plurality of standard target sub-regions.

12. The palm print recognition method according to claim 10, wherein the convolving merged first features of the standard target sub-regions comprises:
using the plurality of standard target sub-regions as current standard target sub-regions in turn;
convolving, using a first matrix in a convolutional encoding model, a first feature of the current standard target sub-region to obtain a first base value of the current standard target sub-region;
convolving, using a second matrix in the convolutional encoding model, the first features of the plurality of standard target sub-regions to obtain second base values corresponding to the plurality of standard target sub-regions;
performing a normalized exponential operation on products of the first base value and the plurality of second base values to obtain attention weights of the plurality of standard target sub-regions to the current standard target sub-region;
convolving, using a third matrix in the convolutional encoding model, the first features of the plurality of standard target sub-regions to obtain third base values corresponding to the plurality of standard target sub-regions; and
performing, using the attention weights, a weighted sum on a plurality of third base values to obtain a convolution result of the current standard target sub-region.

13. The palm print recognition method according to claim 1, wherein the second feature of the target region is a first feature vector; and
wherein determining the palm print recognition result corresponding to the target palm image based on the second feature of the target region comprises:
acquiring a reference feature vector library, the reference feature vector library comprising a plurality of reference feature vectors, and each reference feature vector corresponding to an object;
determining distances among the first feature vector and the reference feature vectors in the reference feature vector library; and
using the object corresponding to the reference feature vector with a smallest distance as the palm print recognition result.

14. The palm print recognition method according to claim 13, wherein acquiring the reference feature vector library comprises:
acquiring reference palm images of a plurality of reference objects;
determining a reference region in the reference palm image, the reference region being a region in which the palm print information richness in the reference palm image satisfies the preset condition;
determining a plurality of reference sub-regions in the reference region, the plurality of reference sub-regions not overlapping with each other; and
inputting first features of the plurality of reference sub-regions into a cascaded projection convolution model and convolutional encoding model to obtain the reference feature vectors corresponding to the plurality of reference objects, and forming the reference feature vector library by the reference feature vectors corresponding to the plurality of reference objects.

15. The palm print recognition method according to claim 14, wherein the projection convolution model and the convolutional encoding model are jointly trained in the following manners:
acquiring a sample palm image pair set, the sample palm image pair set comprising a plurality of sample palm image pairs, each of the sample palm image pairs comprising a first palm image of a first sample object and a second palm image of a second sample object, and the first sample object and the second sample object being different objects;
determining, for each of the sample palm image pairs, a first sample region in the first palm image and a second sample region in the second palm image;
determining a plurality of first sample sub-regions in the first sample region, the plurality of first sample sub-regions not overlapping with each other; and determining a plurality of second sample sub-regions in the second sample region, the plurality of second sample sub-regions not overlapping with each other;
inputting first features of the plurality of first sample sub-regions into the cascaded projection convolution model and convolutional encoding model to obtain a first sample feature vector, and inputting first features of the plurality of second sample sub-regions into the cascaded projection convolution model and convolutional encoding model to obtain a second sample feature vector;
determining a loss function based on distances of the first sample feature vector and the second sample feature vector; and
jointly training the projection convolution model and the convolutional encoding model based on the loss function.

16. The palm print recognition method according to claim 15, wherein determining the loss function based on the distances of the first sample feature vector and the second sample feature vector comprises:
determining the distances for the sample palm image pairs;
averaging the distances of the sample palm image pairs in the sample palm image pair set to obtain an average distance; and
determining the loss function based on the average distance.

17. A palm print recognition apparatus, comprising:
at least one memory configured to store computer program code; and
at least one processor configured to read the program code and operate as instructed by the program code, the program code comprising:
first acquisition code configured to cause at least one of the at least one processor to acquire a target palm image;
second acquisition code configured to cause at least one of the at least one processor to determine a target region in the target palm image, the target region being a region in which palm print information richness in the target palm image satisfies a preset condition;
third acquisition code configured to cause at least one of the at least one processor to determine a plurality of target sub-regions in the target region, the plurality of target sub-regions not overlapping with each other;
fourth acquisition code configured to cause at least one of the at least one processor to determine a second feature of the target region based on first features of the plurality of target sub-regions; and
fifth acquisition code configured to cause at least one of the at least one processor to determine a palm print recognition result corresponding to the target palm image based on the second feature of the target region.

18. The palm print recognition apparatus according to claim 17, wherein second acquisition code is further configured to cause at least one of the at least one processor to:
determine a target base point in the target palm image; and
determine the target region in the target palm image based on the target base point.

19. The palm print recognition apparatus according to claim 18, wherein the target base point comprises a first target base point, a third target base point, and a second target base point located between the first target base point and the third target base point; and
wherein the second acquisition code is further configured to cause at least one of the at least one processor to:
establish a rectangular coordinate system based on a connecting line between the first target base point and the third target base point, and a straight line that is perpendicular to the connecting line and passes through the second target base point;
determine a target region center on the rectangular coordinate system; and
determine the target region based on the target region center.

20. A non-transitory computer-readable storage medium, storing computer code which, when executed by at least one processor, causes the at least one processor to at least:
acquire a target palm image;
determine a target region in the target palm image, the target region being a region in which palm print information richness in the target palm image satisfies a preset condition;
determine a plurality of target sub-regions in the target region, the plurality of target sub-regions not overlapping with each other;
determine a second feature of the target region based on first features of the plurality of target sub-regions; and
determine a palm print recognition result corresponding to the target palm image based on the second feature of the target region.
